(19) United States
(12) Patent Application Publication
(10) Pub. No.: US 2003/0138744 A1
(43) Pub. Date: Jul. 24, 2003

(54) Photothermographic material

(76) Inventor: Tadashi Ito, Minami-ashigara-shi (JP)

Correspondence Address: BIRCH STEWART KOLASCH & BIRCH, PO BOX 747, FALLS CHURCH, VA, 22040-0747, US

(21) Appl. No.: 10/209,924

(22) Filed: Aug. 2, 2002

(30) Foreign Application Priority Data
Aug. 2, 2001 (JP) 2001-234342

(51) Int. Cl. G03C 1/498; G03C 1/76

(52) U.S. Cl. 430/523; 430/620; 430/950

(57) ABSTRACT

Disclosed is a photothermographic material having one or more image-forming layer and one or more layers on the outermost image-forming layer, wherein at least one of the layers on the outermost image-forming layer is a non-photosensitive layer having a thickness of 2.8-8 μm and at least one layer prepared by applying a coating solution containing 30 weight % or more of an organic solvent is formed between the support and the non-photosensitive layer. The photothermographic material shows little fluctuation of image line width and little generation of density unevenness and can form an image of high contrast and high maximum density with heat development under a highly humid environment.

### TECHNICAL FIELD

The present invention relates to a photothermographic material, in particular, a photothermographic material for scanners and image setters, which is suitable for photomechanical processes. More precisely, the present invention relates to a photothermographic material that shows little loading of image line widths and little density unevenness and can provide high contrast and high performance concerning maximum density with heat development under a highly humid environment.

### RELATED ART

Various image formation methods in which a photosensitive material having a photosensitive image-forming layer on a support is exposed imagewise to form an image are known. Among these, methods of heat-developing a photosensitive material to form an image are known as methods that contribute to environmental protection and enable simplification of image formation systems. In recent years, reduction of amount of waste processing solutions is strongly desired in the field of photomechanical processes from the standpoints of environmental protection and space saving. Therefore, techniques relating to photothermographic materials for use in photomechanical processes are required to be developed, which enable efficient exposure by a laser scanner or laser image setter and formation of a clear black image having high resolution and sharpness. Such photothermographic materials can provide users with a simple and non-polluting heat development processing system that eliminates the use of solution-type processing chemicals.

Methods for forming images by heat development are described in, for example, U.S. Pat. Nos. 3,152,904, 3,457,075 and D. Klosterboer, Imaging Processes and Materials, “Thermally Processed Silver Systems A”, 8th ed., Chapter 9, page 279, compiled by J. Sturge, V. Walworth and A. Shepp, Neblette (1989). Such a photothermographic material contains a reducible non-photosensitive silver source (e.g., silver salt of an organic acid), a photocatalyst (e.g., silver halide) in a catalytically active amount and a reducing agent for silver, which are usually dispersed in an organic binder matrix. The photosensitive material is stable at an ambient temperature, but when the material is heated at a high temperature (e.g., 80° C. or higher) after light exposure, silver is produced through an oxidation-reduction reaction between the reducible silver source (which functions as an oxidizing agent) and the reducing agent. The oxidation-reduction reaction is accelerated by catalytic action of a latent image generated upon exposure. The silver produced by the reaction of the reducible silver salt in the exposed area shows black color and this presents a contrast to the non-exposed area to form an image.

Such a photothermographic material is produced by applying coating solutions prepared by dissolving various materials in a solvent to a support to form multiple layers including an image-forming layer. As the solvent of the coating solutions, an organic solvent such as toluene and methyl ethyl ketone may be used. A photosensitive material utilizing an organic solvent as the solvent of coating solutions may suffer from density fluctuation due to fluctuation of development temperature or density fluctuation with time. However, occurrence of such a phenomenon can be suppressed by keeping residual amount of the solvent constant after the coating as described in Japanese Patent Laid-open Publication (Kokai, hereinafter referred to as JP-A) No. 6-301140.

Meanwhile, for use in printing plate making processes, a photosensitive material that can provide an image of high contrast is required. As a technique for obtaining such high contrast, use of a hydrazine compound has been known as described in U.S. Pat. Nos. 5,545,505 and 5,464,738. However, when such a technique for obtaining high contrast is employed, loading of image line widths becomes likely to occur and unevenness of density may be generated in heat development under a highly humid environment. Furthermore, since films for making printing plates have a large size, they suffer from a problem of being more likely to cause unevenness of density. Therefore, there has been desired a photothermographic material that shows little loading of image line widths and no density unevenness, and can provide high contrast and high performance concerning maximum density with heat development under a highly humid environment.

### SUMMARY OF THE INVENTION

In view of the aforementioned problems of conventional techniques, an object of the present invention is to provide a photothermographic material for photomechanical processes, in particular, for scanners and image setters, that shows little loading of image line widths and little generation of density unevenness, and can form an image of high contrast and high maximum density with heat development under a highly humid environment.

As a result of the assiduous studies of the inventor of the present invention, it was found that the aforementioned object could be achieve by applying a coating solution containing 30 weight % or more of an organic solvent to a support to form a layer and forming a non-photosensitive layer having a particular thickness thereon, and thus the present invention was accomplished.

That is, the present invention provides a photothermographic material containing a silver salt of an organic acid, a photosensitive silver halide, a reducing agent, a high contrast agent and a binder on a support and having one or more image-forming layer and one or more layers on the outermost image-forming layer, wherein at least one of the layers on the outermost image-forming layer is a non-photosensitive layer having a thickness of 2.8-8 μm and at least one layer prepared by applying a coating solution containing 30 weight % or more of an organic solvent is formed between the support and the non-photosensitive layer.

In the photothermographic material of the present invention, the layer formed by applying a coating solution containing 30 weight % or more of an organic solvent is preferably an image-forming layer. Further, the non-photosensitive layer preferably has a thickness of 3-8 μm. Furthermore, 50% by weight or more of binder in the non-photosensitive layer preferably consists of a cellulose derivative, in particular, cellulose acetate butyrate.

In the photothermographic material of the present invention, the non-photosensitive layer preferably contains a silica matting agent having a mean particle size of 3.5 μm or less and a monodispersion degree of 30% or less for particle size. Further, the photothermographic material of the present invention is preferably subjected to heat development in a state that it contains 5-300 mg/m² of residual solvent after coating and drying.

The high contrast agent contained in the photothermographic material of the present invention preferably consists of at least one compound selected from the group consisting of substituted alkene derivatives represented by the following formula (1), substituted isoxazole derivatives represented by the following formula (2) and particular acetal compounds represented by the following formula (3).

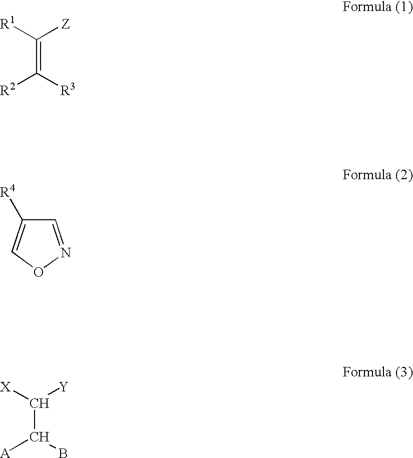

In the formula (1), R¹, R²and R³each independently represent a hydrogen atom or a substituent, and Z represents an electron-withdrawing group or a silyl group. In the formula (1), R¹ and Z, R² and R³, R¹ and R², or R³ and Z may bond to each other to form a ring structure. In the formula (2), R⁴ represents a substituent. In the formula (3), X and Y each independently represent a hydrogen atom or a substituent, and A and B each independently represent an alkoxyl group, an alkylthio group, an alkylamino group, an aryloxy group, an arylthio group, an anilino group, a heterocyclyloxy group, a heterocyclylthio group or a heterocyclylamino group. In the formula (3), X and Y, or A and B may bond to each other to form a ring structure.

The photothermographic material of the present invention is preferably in the form of a sheet having a width of 550-650 mm and a length of 1-65 m and in a state that a part or all of the material is rolled around a core member of cylindrical shape so that the image-forming layer side can be exposed to the outside.

The photothermographic material of the present invention can provide an image of high contrast and high maximum density while showing little image line width fluctuation and little generation of density unevenness even with heat development in a highly humid environment.

### BRIEF DESCRIPTION OF THE DRAWING

FIG. 1 is a side view of an exemplary heat development apparatus used for heat development of the photothermographic material of the present invention. In the figure, there are shown a photothermographic material 10, carrying-in roller pairs 11, taking-out roller pairs 12, rollers 13, a flat surface 14, heaters 15, and guide panels 16. The apparatus consists of a preheating section A, a heat development section B, and a gradual cooling section C.

### BEST MODE FOR CARRYING OUT THE INVENTION

The photothermographic material of the present invention will be explained in detail hereafter. In the present specification, ranges indicated with “-” mean ranges including the numerical values before and after “-” as the minimum and maximum values.

The photothermographic material of the present invention contains at least a silver salt of an organic acid, a photosensitive silver halide, a reducing agent, a high contrast agent and a binder on a support and has at least one image-forming layer. It is characterized by having a non-photosensitive layer with a thickness of 2.8-8 μm on one side of the image-forming layer remoter from the support and at least one layer formed by applying a coating solution containing 30 weight % or more of an organic solvent between the support and the non-photosensitive layer.

The layer formed by applying a coating solution containing 30 weight % or more of an organic solvent may be any of layers present between the support and the non-photosensitive layer having a thickness of 2.8-8 μm. For example, it may be an image-forming layer or a non-photosensitive layer. However, it is preferably an image-forming layer.

The photothermographic material of the present invention is preferably made into, for example, a sheet having a width of 550-650 mm and a length of 1-65 m and preferably incorporated into a heat development system in a state that a part or all of the material is rolled around a core member of cylindrical shape. The photothermographic material is preferably rolled up so that the image-forming layer side can be exposed to the outside.

The silver salt of an organic acid, photosensitive silver halide, reducing agent, high contrast agent and binder constituting the photothermographic material of the present invention will be explained in detail, respectively. Optional ingredients will be also explained.

The photothermographic material contains a reducible silver salt of an organic acid. As the silver salt of an organic acid, an aliphatic acid silver salt is preferred. The aliphatic acid silver salt is a silver salt of an aliphatic acid containing a reducible silver source, and a silver salt of an aliphatic carboxylic acid having a long chain (containing 10-30 carbon atoms, preferably 15-25 carbon atoms) is especially preferred. Preferred examples of the aliphatic acid silver salt are disclosed in Research Disclosure Nos. 17029 and 29963, and include, for example, silver salts of an aliphatic acid such as oxalic acid, behenic acid, arachidic acid, stearic acid, palmitic acid and lauric acid. Particularly preferred is at least one compound selected from silver behenate, silver arachidinate and silver stearate.

The silver salt of an organic acid can be obtained by mixing a water-soluble silver compound with an aliphatic acid that form a complex with silver, and the forward mixing method, reverse mixing method, simultaneous mixing method, controlled double jet method as disclosed in JP-A-9-127643 and so forth are preferably used. For example, an aliphatic acid is added with an alkali metal salt (e.g., sodium hydroxide, potassium hydroxide etc.) to produce an aliphatic acid alkali metal salt soap (e.g., sodium behenate, sodium arachidate etc.) and then the soap and silver nitrate or the like are added by the controlled double jet method to prepare crystals of silver salt of an aliphatic acid. At that time, silver halide grains may be mixed.

The silver salt of an organic acid may be in the form of tabular grain. Thickness of the tabular grain is preferably 0.005-0.2 μm, more preferably 0 005-0.15 μm, still more preferably 0.005-0.1 μm. Further, tabular ratio TA defined by the following equation is preferably 2-200, more preferably 3-100.

TA=B/D

(B: project area of aliphatic acid silver salt tabular grain, D: thickness of aliphatic acid silver salt tabular grain)

Further, it is preferred that tabular grains having a tabular ratio of 2 or more should constitute 50% or more, more preferably 55-100%, still more preferably 60-100%, of the total organic acid silver salt grains.

As a method of obtaining a tabular ratio in the desired range, there are, for example, the method of controlling pH, temperature, electric potential, velocity etc. at the time of adding silver nitrate into an NaOH solution of an organic acid (preferably aliphatic acid), the method of controlling, pH temperature, electric potential, velocity etc. at the time of adding an NaOH solution of an organic acid (preferably aliphatic acid) into a silver nitrate solution, the method of controlling, pH temperature, electric potential, velocity etc. at the time of simultaneously adding and mixing an NaOH solution of an organic acid (preferably aliphatic acid) and a silver nitrate solution by the controlled double jet method, the method of ripening silver salt of an organic acid after preparation in a reaction vessel, the method of dispersing silver salt of an organic acid after preparation with a binder in a dispersing apparatus and so forth, and these methods are used each alone or in any combination. Among these, the method of dispersing silver salt of an organic acid after preparation with a binder, activating agent and so forth in a dispersing apparatus to form tabular grains of organic acid silver salt is preferably used.

The mean grain size of the organic acid silver salt grains is preferably 0.2-1.2 μm, more preferably 0.35-1 μm. To obtain the mean grain size used herein, 300 or more grains are randomly extracted from the aforementioned grains and projected areas of individual grains are measured by the replica method or the like. The arithmetic average of diameters of the projected areas considered as circles are calculated to obtain the mean grain size. Further, the grains of the silver salt of an organic acid are preferably monodispersed. The term monodispersed state used herein has the same meaning as that used for the silver halide mentioned later, and the monodispersion degree is preferably 1-30. By adjusting the monodispersion degree to be in this range, there can be provided a photosensitive material showing high density and excellent in image storability.

It is not preferred that acicular grains of silver salt of an organic acid coexsist with the aforementioned tabular grains of silver salt of an organic acid in order to maintain transparency after the treatment. When grains having a long axis length of 1 μm or more constitute 50% or more of the total number of grains as disclosed in examples of JP-A-9-68772, transparency after the treatment may be markedly degraded.

The photothermographic material of the present invention contains a silver halide emulsion. Silver halide grains contained in the emulsion function as a photosensor. It is preferable to use silver halide gains having a small grain size in order to reduce cloudiness after the image formation and improve quality of formed images, and the mean grain size is preferably 0.1 μm or less, more preferably 0.01-0.1 μm, particularly preferably 0.02-0.08 μm. The grain size used herein means a ridge length of a silver halide grain for normal crystals including cubic crystals and octahedral crystals, or a diameter of a sphere having the same volume as a silver halide grain for crystals that are not normal crystals, e.g., spherical grains, rod-like grains and tabular grains. The silver halide is preferably monodispersed. The monodispersed state used herein means that the monodispersion degree obtained according to the following equation is 40% or less. More preferred are grains showing a monodispersion degree of 30% or less, particularly preferably 0.1-20%. Monodispersion degree={(Standard deviation of grain size)/(Average of grain size)}×100

Although shape of the silver halide grain is not particularly limited, it is desirable to use those having a high proportion of [100] face in terms of the Miller index, and this proportion is preferably at least 50%, more preferably at least 70%, still more preferably at least 80%. The proportion of Miller index [100] face can be determined by using the method described in T. Tani, J. Imaging Sci., 29, 165 (1985), which utilizes the difference in adsorption of a sensitizing dye to [111] face and [100] face.

Another preferred form of silver halide is a form of tabular grain. The tabular grain used herein means a grain showing an aspect ratio=r/h of 3 or more, where square root of projected area is defined as r μm and thickness along the direction perpendicular to the projected plane is defined as h μm. The aspect ratio is particularly preferably 3-50. The grain size is preferably 0.1 μm or less, more preferably 0.01-0.08 μm. Such grains are disclosed in U.S. Pat. Nos. 5,264,337, 5,314,798, 5,320,958 and so forth, and desired tabular grains can be easily obtained. When these tabular grains are used in the present invention, sharpness of images is also improved.

The photosensitive silver halide emulsion used for the present invention is not particularly limited as for the halogen composition, and any of silver chloride, silver chlorobromide, silver chloroiodobromide, silver bromide, silver iodobromide and silver iodide may be used. The emulsion used in the present invention can be prepared based on the methods described in P. Glafkides, Chimie et Phisique Photographique, Paul Montel, 1967; G. F. Duffin, Photographic Emulsion Chemistry, The Focal Press, 1966; V. L. Zelikman et al., Making and Coating of Photographic Emulsion, The Focal Press, 1964 and so forth. That is, the preparation can be performed by any of the acidic method, neutral method, ammonia method and so forth. As the method of reacting a soluble silver salt and a soluble halide salt, any of the single-side mixing method, the simultaneous mixing method, combination thereof and so forth may be used. The silver halide may be added to a layer by any method, and the silver halide is provided so as to locate near the reducible silver source. Further, the silver halide may be prepared by converting a part or all of silver in silver salt of an organic acid into silver halide through a reaction of silver salt of an organic acid and halogen ion, or silver halide may be prepared beforehand and added to a solution for preparing silver salt of an organic acid, and these methods may be used in combination. However, the latter is preferred. In general, the silver halide is preferably contained in the amount of 0.75-30 weight % with respect to the silver salt of an organic acid.

The silver halide preferably contains metal ions of metal belonging to Group VI to Group XI in the periodic table of elements, and the metal is preferably W, Fe, Co, Ni, Cu, Ru, Rh, Pd, Re, Os, Ir, Pt or Au. These metal ions can be introduced into the silver halide in the form of a metal complex or a metal complex ion. As such metal complexe or metal complex ion, 6-coordinated metal complexes represented by the following formula (X) are preferred.

[ML₆]^{m} Formula (X)

In the formula, M represents a transition metal selected from the elements of Group VI to Group XI in the periodic table of elements, L represents a ligand, and m represents 0, 1−, 2−, 3− or 4−. Two or more of L may be identical to or different from each other or one another. M is preferably rhodium (Rh), ruthenium (Ru), rhenium (Re), iridium (Ir) or osmium (Os). Specific examples of the ligand represented by L include ligands of halide (fluoride, chloride, bromide and iodide), cyanide, cyanate, thiocyanate, selenocyanate, tellurocyanate, azide and aquo, nitrosyl, thionitrosyl and so forth, and preferred are aquo, nitrosyl, thionitrosyl and so forth. When an aquo ligand or ligands exist, number of the aquo ligands is preferably 2 or less.

Specific examples of the transition metal complex ion represented by the aforementioned formula (X) are shown below. However, transition metal complexes that can be used for the present invention are not limited to these.

1: [RhCl₆]³⁻

2: [RuCl₆]³⁻

3: [ReCl₆]³⁻

4: [RuBr₆]³⁻

5: [OsCl₆]³⁻

6: [IrCl₆]⁴⁻

7: [Ru(NO) Cl₅]²⁻

8: [RuBr₄(H₂O)]²⁻

9: [Ru(NO)(H₂O)Cl₄]⁻

10: [RhCl₅(H₂O)]²⁻

11: [Re(NO)Cl₅]²⁻

12: [Re(NO)CN₅]²⁻

13: [Re(NO)ClCN₄]²⁻

14: [Rh(NO)₂Cl₄]⁻

15: [Rh(NO)(H₂O)Cl₄]⁻

16: [Ru(NO)CN₅]²⁻

17: [Fe(CN)₆]³⁻

18: [Rh(NS)Cl₅]²⁻

19: [Os(NO)Cl₅]²⁻

20: [Cr(NO)Cl₅]²⁻

21: [Re(NO)Cl₅]⁻

22: [Os(NS)Cl₄(TeCN)]²⁻

23: [Ru(NS)Cl₅]²⁻

24: [Re(NS)Cl₄(SeCN)]²⁻

25: [Os(NS)Cl(SCN)₄]²⁻

26: [Ir(NO)Cl₅]²⁻

27: [Ir(NS)Cl₅]²⁻

These metal ions, metal complexes and metal complex ions may be used each kind alone or two or more kinds of them containing the same metal or different metal may be used in combination. Content of these metal ions, metal complexes and metal complex ions is generally 1×10⁻⁹ to 1×10⁻² mole, preferably 1×10⁻⁸ to 1×10⁻⁴ mol, per mole of silver halide.

A compound that provides these metals are preferably added at the time of silver halide grain formation so as to be incorporated into silver halide grains, and it may be added in any steps of preparation of silver halide grains, i.e., nucleation, growth, physical ripening and before and after chemical sensitization. In particular, it is preferably added in the step of nucleation, growth or physical ripening, particularly preferably in the step of nucleation or growth, most preferably in the step of nucleation. The addition may be attained by adding divided portions several times, and it may be contained in a silver halide grain uniformly or with a distribution as disclosed in JP-A-63-29603, JP-A-2-306236, JP-A-3-167545, JP-A-4-76534, JP-A-6-110146, JP-A-5-273683 and so forth. Preferably, it is contained in a grain with a distribution.

These metal compounds can be added after being dissolved in water or a suitable organic solvent (e.g., alcohols, ethers, glycols, ketones, ester and amides). For example, there are a method of preliminarily adding an aqueous solution dissolving powder of a metal compound or an aqueous solution dissolving powder of a metal compound together with NaCl or KCl into a solution of water-soluble silver salt or solution of water-soluble halide during the grain formation, a method of simultaneously mixing three kinds of solutions to prepare silver halide grains in which a solution of a metal compound is added as a third aqueous solution when a silver salt solution and a halide solution are mixed simultaneously, a method of adding an aqueous solution of a metal compound to a reaction vessel in a required amount during the grain formation, a method of adding separate silver halide grains preliminarily doped with ions or complex ions of metal at the time of preparation of silver halide to dissolve them and so forth. In particular, the method of adding an aqueous solution of powder of a metal compound or an aqueous solution dissolving a metal compound together with NaCl or KCl into a solution of water-soluble halide is preferred. When they are added to grain surfaces, it is also possible to add an aqueous solution of metal compound in a required amount to a reaction vessel immediately after grain formation, during or after physical ripening or during chemical ripening.

The photosensitive silver halide grains may be desalted by washing methods with water known in the art, such as the noodle washing and flocculation washing.

The photosensitive silver halide grains are preferably subjected to chemical sensitization. As preferred chemical sensitization methods, there can be used sulfur sensitization, selenium sensitization, tellurium sensitization, noble metal sensitization utilizing a gold compound or platinum, palladium or iridium compound and reduction sensitization as well known in this field.

In the present invention, in order to prevent loss of clarity of a plate making film material, the silver halide and the silver salt of an organic acid are preferably used in a total amount of 0.5-2.2 g in terms of silver amount per 1 m². An amount in this range can provide a high contrast image. Further, amount of the silver halide to the total amount of silver is 50% or less, preferably 25% or less, more preferably 0.1-15%, in terms of weight.

The photothermographic material of the present invention preferably shows photosensitivity to a light of a wavelength of 700-850 nm. In order to show photosensitivity to a light of the aforementioned wavelength region, the aforementioned silver halide emulsion is preferably subjected to spectral sensitization with a sensitizing dye. For example, there are preferably selected thiacarbocyanines disclosed in JP-B-48-42172, JP-B-51-9609, JP-B-55-39818, JP-A-62-284343, JP-A-2-105135 and so forth for LED light sources and infrared semiconductor laser light sources, tricarbocyanines disclosed in JP-A-59-191032 and JP-A-60-80841 and dicarbocyanines containing 4-quinoline nucleus represented by the formula (IIIa) or (IIIb) disclosed in JP-A-59-192242 and JP-A-3-67242 and so forth for infrared semiconductor laser light sources. Furthermore, when wavelength of infrared laser light source is 750 nm or more, more preferably 800 nm or more, sensitizing dyes disclosed in JP-A-4-182639, JP-A-5-341432, JP-B-6-52387, JP-B-3-10931, U.S. Pat. No. 5,441,866, JP-A-7-13295 and so forth are preferably used to meet lasers of such a wavelength region. These sensitizing dyes may be used each kind alone, or two or more kinds of them may be used in combination for supersensitization. Further, together with a sensitizing dye, a dye that does not have spectral sensitization effect in itself or a substance that does not substantially absorb visible light but shows supersensitization effect may be contained.

Useful sensitizing dyes, combinations of dyes that exhibit supersensitization, and materials that show supersensitization are described in, for example, Research Disclosure No. 17643, page 23, Item IV-J (December 1978), JP-B-49-25500, JP-B-43-4933, JP-A-59-19032, JP-A-59-192242, JP-A-62-123454, JP-A-3-15049, JP-A-7-146527 and so forth.

The photothermographic material of the present invention may contain a mercapto compound, disulfide compound or thione compound with the purposes of controlling the development by inhibiting or accelerating the development, improving spectral sensitization efficiency and improving storage stability before or after the development. As the mercapto compound, those compounds represented by the following formula (4) or (5) are preferred.

Ar—SM Formula (4)

Ar—S—S—Ar Formula (5)

In the formulas, M is a hydrogen atom or an alkali metal atom, and Ar is a heteroaromatic ring or condensed heteroaromatic ring containing one or more nitrogen, sulfur, oxygen, selenium or tellurium atoms.

The heteroaromatic ring represented by Ar is preferably selected from benzimidazole, naphthimidazole, benzothiazole, naphthothiazole, benzoxazole, naphthoxazole, benzoselenazole, benzotellurazole, imidazole, oxazole, pyrazole, triazole, thiadiazole, tetrazole, triazine, pyrimidine, pyridazine, pyrazine, pyridine, purine, quinoline and quinazolinone. The heteroaromatic ring may have one or more substituents selected from, for example, the group of substituents consisting of a halogen (e.g., Br, Cl), hydroxy, amino, carboxy, alkyl (e.g., alkyl having one or more carbon atoms, preferably 1-4 carbon atoms) and alkoxy (e.g., alkoxy having one or more carbon atoms, preferably 1-4 carbon atoms).

Examples of Ar—S (mercapto-substituted heteroaromatic compound) in the formulas (4) and (5) include 2-mercaptobenzimidazole, 2-mercaptobenzoxazole, 2-mercaptobenzothiazole, 2-mercapto-5-methylbenzimidazole, 6-ethoxy-2-mercaptobenzothiazole, 2,2′-dithiobis-benzothiazole, 3-mercapto-1,2,4-triazole, 4,5-diphenyl-2-imidazol-ethiol, 2-mercaptoimidazole, 1-ethyl-2-mercaptobenzimidazole, 2-mercaptoquinoline, 8-mercaptopurine, 2-mercapto-4(3H) -quinazo-linone, 7-trifluoromethyl-4-quinolinethiol, 2,3,5,6-tetrachloro-4-pyridinethiol, 4-amino-6-hydroxy-2-mercaptopyrimidine monohydrate, 2-amino-5-mercapto-1,3,4-thiadiazole, 3-amino-5-mercapto-1,2,4-triazole, 4-hydroxy-2-mercaptopyrimidine, 2-mercaptopyrimidine, 4,6-diamino-2-mercaptopyrimidine, 2-mercapto-4-methylpyrimidine hydrochloride, 3-mercapto-5-phenyl-1,2,4-triazole, 2-mercapto-4-phenyloxazole and so forth. The compounds represented by the formula (4) or (5) are preferably added in an amount of from 0.001-1.0 mole, more preferably from 0.01-0.3 mole, per mole of silver in an emulsion layer.

The photothermographic material may to contain a compound showing infrared absorption at a wavelength of 700-900 nm for antihalation purpose. As the infrared absorption compound, there can be used polymethine dyes, squarylium dyes and so forth disclosed in JP-A-59-6481, JP-A-59-182436, U.S. Pat. Nos. 4,271,263, 4,594,312, European Patent Publication Nos. 533,008, 652,473, JP-A-2-216140, JP-A-4-348339, JP-A-7-191432, JP-A-7-301890, JP-A-9-230531, JP-A-10-104779, JP-A-10-104785, International Patent Publication in Japanese (Kohyo) No. 9-509503 and so forth.

Although the layer to which the antihalation dye is added is not particularly limited, it is preferably added to an undercoat layer. It is preferably added to an undercoat layer coated on the image-forming layer side. When the undercoat layer consists of two or more layers, it is desirably added to a layer most close to the image-forming layer. Although its amount varies depending on the desired purpose, it is generally 0.1-1000 mg/m², preferably 1-200 mg/m².

The photothermographic material of the present invention contains a reducing agent for reducing silver ions. As the reducing agent, there are preferably used those disclosed in U.S. Pat. Nos. 3,770,448, 3,773,512, 3,593,863, Research Disclosure Nos. 17029 and 29963. Specifically, the followings can be mentioned: aminohydroxycycloalkenone compounds (e.g., 2-hydroxypiperidino-2-cyclohexenone); esters of aminoreductones (e.g., piperidinohexose reductone monoacetate) acting as precursors of reducing agent; N-hydroxyurea derivatives (e.g., N-p-methylphenyl-N-hydroxyurea); hydrazones of aldehyde or ketone (e.g., anthracenaldehydephenyl hydrazone), phosphor-amidophenols; phosphor-amidanilines; polyhydroxybenzenes (e.g., hydroquinone, tert-butyl-hydroquinone, isopropyihydroquinone, (2,5-dihydroxyphenyl)methylsulfone); sulfhydroxamic acids (e.g., benzenesulfhydroxamic acid); sulfonamidanilines (e.g., 4-(N-methanesulfonamido)aniline); 2-tetrazolylthiohydroquinones (e.g., 2-methyl-S-(l-phenyl-5-tetrazolylthio)hydroquinone); tetrahydroquinoxalines (e.g., 1,2,3,4-tetrahydroquinoxaline); amidoxins; combination of azines (e.g., aliphatic carboxylic acid aryl hydrazides) and ascorbic acid; combination of polyhydroxybenzene and hydroxylamine, reductone and/or hydrazine; hydroxamic acids; combinations of azine and sulfonamidophenol; a-cyanophenylacetic acid derivatives; combinations of bis-β-naphthol and 1,3-dihydroxybenzene derivative; 5-pyrazolones; sulfonamidophenol reducing agents; 2-phenylinedan-1,3-diones; chromans; 1,4-dihydroxypyridines (e.g., 2,6-dimethoxy-3,5-dicarboethoxy-1,4-dihydropyridine); bis-phenols (e.g., bis(2-hydroxy-3-tert-butyl-5-methylphenyl)methane, bis(6-hydroxy-m-tri)mesitol, 2,2-bis(4-hydroxy-3-methylphenyl)-propane, 4,5-ethylidene-bis(2-tert-butyl-6-methyl)phenol); ultra-violet-sensitive ascorbic acid derivatives; 3-pyrazolidones and so forth. Particularly preferred as the reducing agent are hindered phenols.

As hindered phenols used as the reducing agent, compounds represented by the following formula (a) can be mentioned.

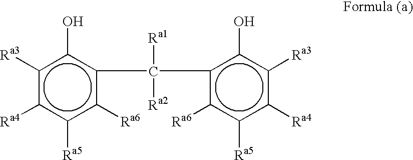

In the formula, R^{a1} and R^{a2} each independently represent a hydrogen atom or an alkyl group having 1-10 carbon atoms (e.g., —C₄H₉, 2,4,4-trimethylpentyl), provided that at least one of them is a hydrogen atom. R^{a3} to R^{a6} each independently represent a hydrogen atom or an alkyl group having 1-5 carbon atoms (e.g., methyl gorup, ethyl group, tert-butyl group), and it is preferred that R^{a4} and R^{a6} should represent a hydrogen atom and R^{a3} and R^{a5} should represent an alkyl group having 1-5 carbon atoms.

Specific examples of the compounds represented by the aforementioned formula (a) (Exemplary Compounds a-1 to a-7) will be shown below. However, compounds that can be used for the present invention are not limited to these examples.

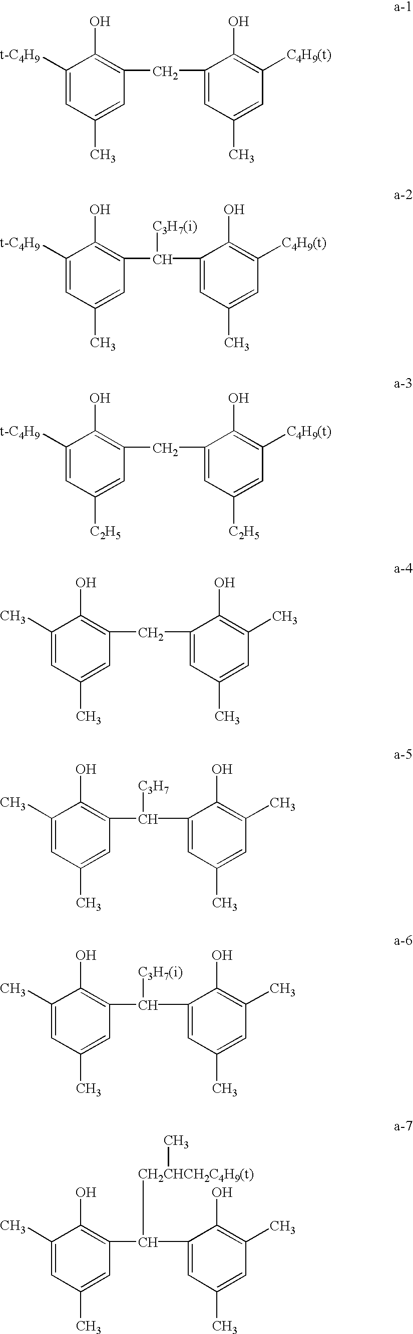

The amount of the reducing agents including the reducing agents represented by the aforementioned formula (a) is preferably 1×10⁻² to 10 moles, more preferably 1×10⁻² to 1.5 moles, per mole of silver.

The high contrast agent that is an essential component of the photothermographic material of the present invention will be explained. As the high contrast agent, there are preferably used substituted alkene derivatives represented by the aforementioned formula (1), substituted isooxazole derivatives represented by the aforementioned formula (2) and particular acetal compounds represented by the aforementioned formula (3).

The compounds represented by the formula (1), (2) or (3) preferably used in the present invention will be explained in detail, respectively.

In the formula (1), R¹, R² and R³ each independently represents a hydrogen atom or a substituent, and Z represents an electron-withdrawing group or a silyl group. In the formula (1), R¹ and Z, R² and R³, R¹ and R², or R³ and Z may bond to each other to form a ring structure In the formula (2), R⁴ represents a substituent. In the formula (3), X and Y each independently represents a hydrogen atom or a substituent, and A and B each independently represents an alkoxy group, an alkylthio group, an alkylamino group, an aryloxy group, an arylthio group, an anilino group, a heterocyclyloxy group, a heterocyclylthio group or a heterocyclylamino group. In the formula (3), X and Y or A and B may bond to each other to form a ring structure.

The substituted alkene derivatives represented by the formula (1) will be described in detail below.

In the formula (1), R¹, R² and R³ each independently represent a hydrogen atom or a substituent, and Z represents an electron-withdrawing group or a silyl group. In the formula (1), R¹ and Z, R² and R³, R¹ and R², or R³ and Z may bond to each other to form a ring structure.

When R¹, R² and R³ represent a substituent, examples of the substituent include, for example, a halogen atom (e.g., fluorine atom, chlorine atom, bromide atom, iodine atom), an alkyl group (including an aralkyl group, a cycloalkyl group and active methine group), an alkenyl group, an alkynyl group, an aryl group, a heterocyclic group (including N-substituted nitrogen-containing heterocyclic group), a quaternized nitrogen-containing heterocyclic group (e.g. pyridinio group), an acyl group, an alkoxycarbonyl group, an aryloxycarbonyl group, a carbamoyl group, a carboxy group or a salt thereof, an imino group, an imino group substituted at N atom, a thiocarbonyl group, a sulfonylcarbamoyl group, an acylcarbamoyl group, a sulfamoylcarbamoyl group, a carbazoyl group, an oxalyl group, an oxamoyl group, a cyano group, a thiocarbamoyl group, a hydroxy group or a salt thereof, an alkoxy group (including a group containing an ethyleneoxy group or propyleneoxy group repeating unit), an aryloxy group, a heterocyclyloxy group, an acyloxy group, an (alkoxy or aryloxy) carbonyloxy group, a carbamoyloxy group, a sulfonyloxy group, an amino group, an (alkyl, aryl or heterocyclyl)amino group, an acylamino group, a sulfonamido group, a ureido group, a thioureido group, an imido group, an (alkoxy or aryloxy)carbonylamino group, a sulfamoylamino group, a semicarbazido group, a thiosemicarbazido group, a hydrazino group, a quaternary ammonio group, an oxamoylamino group, an (alkyl or aryl)sulfonylureido group, an acylureido group, an acylsulfamoylamino group, a nitro group, a mercapto group, an (alkyl, aryl or heterocyclyl)thio group, an acylthio group, an (alkyl or aryl) sulfonyl group, an (alkyl or aryl) sulfinyl group, a sulfo group or a salt thereof, a sulfamoyl group, an acylsulfamoyl group, a sulfonylsulfamoyl group or a salt thereof, a phosphoryl group, a group containing phosphoramido or phosphoric acid ester structure, a silyl group, a stannyl group and so forth.

These substituents each may further be substituted with any of the above-described substituents.

The electron-withdrawing group represented by Z in the formula (1) is a substituent having a Hammett's substituent constant σp of a positive value, and specific examples thereof include a cyano group, an alkoxycarbonyl group, an aryloxycarbonyl group, a carbamoyl group, an imino group, an imino group substituted at N atom, a thiocarbonyl group, a sulfamoyl group, an alkylsulfonyl group, an arylsulfonyl group, a nitro group, a halogen atom, a perfluoroalkyl group, a perfluoroalkanamido group, a sulfonamido group, an acyl group, a formyl group, a phosphoryl group, a carboxy group (or a salt thereof), a sulfo group (or a salt thereof), a heterocyclic group, an alkenyl group, an alkynyl group, an acyloxy group, an acylthio group, a sulfonyloxy group and an aryl group substituted with the above-described electron-withdrawing group. The heterocyclic group is a saturated or unsaturated heterocyclic group and examples thereof include a pyridyl group, a quinolyl group, a pyrazinyl group, a quinoxalinyl group, a benzotriazolyl group, an imidazolyl group, a benzimidazolyl group, a hydantoin-1-yl group, a succinimido group, a phthalimido group and so forth.

The electron-withdrawing group represented by Z in the formula (1) may further have a substituent, and examples of the substituent include those substituents mentioned for the substituent represented by R¹, R² or R³ in the formula (1).

In the formula (1), R¹ and Z, R² and R³, R¹ and R², or R³ and Z may bond to each other to form a ring structure. The ring structure formed is a non-aromatic carbocyclic ring or a non-aromatic heterocyclic ring.

The preferred range of the compound represented by the formula (1) is described below.

The silyl group represented by Z in the formula (1) is preferably and specifically trimethylsilyl group, t-butyldimethylsilyl group, phenyldimethylsilyl group, triethylsilyl group, triisopropylsilyl group or trimethylsilyldimethylsilyl group.

The electron-withdrawing group represented by Z in the formula (1) is preferably a group having a total carbon atom number of 0-30 such as a cyano group, an alkoxycarbonyl group, an aryloxycarbonyl group, a carbamoyl group, a thiocarbonyl group, an imino group, an imino group substituted at N atom, a sulfamoyl group, an alkylsulfonyl group, an arylsulfonyl group, a nitro group, a perfluoroalkyl group, an acyl group, a formyl group, a phosphoryl group, an acyloxy group, an acylthio group, a phenyl group substituted with an arbitrary electron-withdrawing group or the like, more preferably a cyano group, an alkoxycarbonyl group, a carbamoyl group, an imino group, a sulfamoyl group, an alkylsulfonyl group, an arylsulfonyl group, an acyl group, a formyl group, a phosphoryl group, a trifluoromethyl group, a phenyl group substituted with an arbitrary electron-withdrawing group or the like, particularly preferably a cyano group, a formyl group, an acyl group, an alkoxycarbonyl group, an imino group or a carbamoyl group.

The group represented by Z in the formula (1) is preferably an electron-withdrawing group.

The substituent represented by R¹, R² or R³ in the formula (1) is preferably a group having a total carbon atom number of 0-30, and specific examples of the group include a group having the same meaning as the electron-withdrawing group represented by Z in the formula (1), an alkyl group, a hydroxy group (or a salt thereof), a mercapto group (or a salt thereof), an alkoxy group, an aryloxy group, a heterocyclyloxy group, an alkylthio group, an arylthio group, a heterocyclylthio group, an amino group, an alkylamino group, an arylamino group, a heterocyclylamino group, a ureido group, an acylamino group, a sulfonamido group, a substituted or unsubstituted aryl group and so forth.

In the formula (1), R¹ is preferably an electron-withdrawing group, an aryl group, an alkylthio group, an alkoxy group, an acylamino group, a hydrogen atom or a silyl group.

When R¹ represents an electron-withdrawing group, the electron-withdrawing group is preferably a group having a total carbon atom number of 0-30 such as a cyano group, a nitro group, an acyl group, a formyl group, an alkoxycarbonyl group, an aryloxycarbonyl group, a thiocarbonyl group, an imino group, an imino group substituted at N atom, an alkylsulfonyl group, an arylsulfonyl group, a carbamoyl group, a sulfamoyl group, a trifluoromethyl group, a phosphoryl group, a carboxy group (or a salt thereof), a saturated or unsaturated heterocyclic group, more preferably a cyano group, an acyl group, a formyl group, an alkoxycarbonyl group, a carbamoyl group, an imino group, an imino group substituted at N atom, a sulfamoyl group, a carboxy group (or a salt thereof) or a saturated or unsaturated heterocyclic group, particularly preferably a cyano group, a formyl group, an acyl group, an alkoxycarbonyl group, a carbamoyl group or a saturated or unsaturated heterocyclic group.

When R¹ represents an aryl group, the aryl group is preferably a substituted or unsubstituted phenyl group having a total carbon atom number of 6-30. The substituent may be an arbitrary substituent, but an electron-withdrawing substituent is preferred.

In the formula (1), R¹ is more preferably an electron-withdrawing group or an aryl group.

The substituent represented by R² or R³ in the formula (1) is preferably a group having the same meaning as the electron-withdrawing group represented by Z in the formula (1), an alkyl group, a hydroxy group (or a salt thereof), a mercapto group (or a salt thereof), an alkoxy group, an aryloxy group, a heterocyclyloxy group, an alkylthio group, an arylthio group, a heterocyclylthio group, an amino group, an alkylamino group, an anilino group, a heterocyclylamino group, an acylamino group, a substituted or unsubstituted phenyl group or the like.

In the formula (1), it is more preferred that one of R² and R³ is a hydrogen atom and the other is a substituent. The substituent is preferably an alkyl group, a hydroxy group (or a salt thereof), a mercapto group (or a salt thereof), an alkoxy group, an aryloxy group, a heterocyclyloxy group, an alkylthio group, an arylthio group, a heterocyclylthio group, an amino group, an alkylamino group, an anilino group, a heterocyclylamino group, an acylamino group (particularly, a perfluoroalkanamido group), a sulfonamido group, a substituted or unsubstituted phenyl group, a heterocyclic group or the like, more preferably a hydroxy group (or a salt thereof), a mercapto group (or a salt thereof), an alkoxy group, an aryloxy group, a heterocyclyloxy group, an alkylthio group, an arylthio group, a heterocyclylthio group or a heterocyclic group, particularly preferably a hydroxy group (or a salt thereof), an alkoxy group or a heterocyclic group.

In the formula (1), it is also preferred that Z and R¹ or R² and R³ form a ring structure. The ring structure formed is a non-aromatic carbocyclic ring or a non-aromatic heterocyclic ring, preferably a 5-, 6- or 7-membered ring structure having a total carbon atom number including those of substituents of 1-40, more preferably 3-30.

The compound represented by the formula (1) is more preferably a compound where Z represents a cyano group, a formyl group, an acyl group, an alkoxycarbonyl group, an imino group or a carbamoyl group, R¹ represents an electron-withdrawing group or an aryl group, one of R²and R³represents a hydrogen atom and the other represents a hydroxy group (or a salt thereof), a mercapto group (or a salt thereof), an alkoxy group, an aryloxy group, a heterocyclyloxy group, an alkylthio group, an arylthio group, a heterocyclylthio group or a heterocyclic group, more preferably a compound where Z and R¹ form a non-aromatic 5-, 6- or 7-membered ring structure, one of R² and R³ represents a hydrogen atom and the other represents a hydroxy group (or a salt thereof), a mercapto group (or a salt thereof), an alkoxy group, an aryloxy group, a heterocyclyloxy group, an alkylthio group, an arylthio group, a heterocyclylthio group or a heterocyclic group. In such a compound, Z that forms a non-aromatic ring structure together with R¹ is preferably an acyl group, a carbamoyl group, an oxycarbonyl group, a thiocarbonyl group, a sulfonyl group or the like and R¹ is preferably an acyl group, a carbamoyl group, an oxycarbonyl group, a thiocarbonyl group, a sulfonyl group, an imino group, an imino group substituted at N atom, an acylamino group, a carbonylthio group or the like.

The substituted isooxazole derivatives represented by the formula (2) will be described below.

In the formula (2), R⁴ represents a substituent. Examples of the substituent represented by R⁴ include those described for the substituent represented by R¹, R² or R³ in the formula (1).

The substituent represented by R⁴ is preferably an electron-withdrawing group or an aryl group. When R⁴ represents an electron-withdrawing group, the electron-withdrawing group is preferably a group having a total carbon atom number of 0-30 such as a cyano group, a nitro group, an acyl group, a formyl group, an alkoxycarbonyl group, an aryloxycarbonyl group, an alkylsulfonyl group, an arylsulfonyl group, a carbamoyl group, a sulfamoyl group, a trifluoromethyl group, a phosphoryl group, an imino group or a saturated or unsaturated heterocyclic group, more preferably a cyano group, an acyl group, a formyl group, an alkoxycarbonyl group, a carbamoyl group, a sulfamoyl group, an alkylsulfonyl group, an arylsulfonyl group or a heterocyclic group, particularly preferably a cyano group, a formyl group, an acyl group, an alkoxycarbonyl group, a carbamoyl group or a heterocyclic group.

When R⁴ represents an aryl group, the aryl group is preferably a substituted or unsubstituted phenyl group having a total carbon atom number of 0-30. Examples of the substituent include those described for the substituent represented by R¹, R² or R³ in the formula (1).

R⁴ is particularly preferably a cyano group, an alkoxycarbonyl group, a carbamoyl group, a heterocyclic group or a substituted or unsubstituted phenyl group, most preferably a cyano group, a heterocyclic group or an alkoxycarbonyl group.

The particular acetal compounds represented by the formula (3) will be described in detail below.

In the formula (3), X and Y each independently represent a hydrogen atom or a substituent, and A and B each independently represent an alkoxy group, an alkylthio group, an alkylamino group, an aryloxy group, an arylthio group, an anilino group, a heterocyclylthio group, a heterocyclyloxy group or a heterocyclylamino group, and X and Y or A and B may bond to each other to form a ring structure.

Examples of the substituent represented by X or Y in the formula (3) include those described for the substituent represented by R¹, R²or R³ in the formula (1). Specific examples thereof include an alkyl group (including a perfluoroalkyl group and trichloromethyl group), an aryl group, a heterocyclic group, a halogen atom, a cyano group, a nitro group, an alkenyl group, an alkynyl group, an acyl group, a formyl group, an alkoxycarbonyl group, an aryloxycarbonyl group, an imino group, an imino group substituted at N atom, a carbamoyl group, a thiocarbonyl group, an acyloxy group, an acylthio group, an acylamino group, an alkylsulfonyl group, an arylsulfonyl group, a sulfamoyl group, a phosphoryl group, a carboxy group (or a salt thereof), a sulfo group (or a salt thereof), a hydroxy group (or a salt thereof), a mercapto group (or a salt thereof), an alkoxy group, an aryloxy group, a heterocyclyloxy group, an alkylthio group, an arylthio group, a heterocyclylthio group, an amino group, an alkylamino group, an anilino group, a heterocyclylamino group, a silyl group and so forth.

These groups may further have a substituent. X and Y may bond to each other to form a ring structure, and the ring structure formed may be either a non-aromatic carbocyclic ring or a non-aromatic heterocyclic ring.

In the formula (3), the substituent represented by X or Y is preferably a substituent having a total carbon number of 1-40, more preferably 1-30, such as a cyano group, an alkoxycarbonyl group, an aryloxycarbonyl group, a carbamoyl group, an imino group, an imino group substituted at N atom, a thiocarbonyl group, a sulfamoyl group, an alkylsulfonyl group, an arylsulfonyl group, a nitro group, a perfluoroalkyl group, an acyl group, a formyl group, a phosphoryl group, an acylamino group, an acyloxy group, an acylthio group, a heterocyclic group, an alkylthio group, an alkoxy group and an aryl group.

In the formula (3), X and Y more preferably represent a cyano group, a nitro group, an alkoxycarbonyl group, a carbamoyl group, an acyl group, a formyl group, an acylthio group, an acylamino group, a thiocarbonyl group, a sulfamoyl group, an alkylsulfonyl group, an arylsulfonyl group, an imino group, an imino group substituted at N atom, a phosphoryl group, a trifluoromethyl group, a heterocyclic group, a substituted phenyl group or the like, particularly preferably a cyano group, an alkoxycarbonyl group, a carbamoyl group, an alkylsulfonyl group, an arylsulfonyl group, an acyl group, an acylthio group, an acylamino group, a thiocarbonyl group, a formyl group, an amino group, an imino group substituted at N atom, a heterocyclic group, a phenyl group substituted with an arbitrary electron-withdrawing group or the like.

X and Y also preferably bond to each other to form a non-aromatic carbocyclic ring or a non-aromatic heterocyclic ring. The ring structure formed is preferably a 5-, 6- or 7-membered ring having a total carbon atom number of 1-40, more preferably 3-30. X and Y for forming a ring structure preferably represent an acyl group, a carbamoyl group, an oxycarbonyl group, a thiocarbonyl group, a sulfonyl group, an imino group, an imino group substituted at N atom, an acylamino group, a carbonylthio group or the like.

In the formula (3), A and B each independently represent an alkoxy group, an alkylthio group, an alkylamino group, an aryloxy group, an arylthio group, an anilino group, a heterocyclylthio group, a heterocyclyloxy group or a heterocyclylamino group, which may bond to each other to form a ring structure. The group represented by A or B in the formula (3) is preferably a group having a total carbon atom number of 1-40, more preferably 1-30, and the group may further have a substituent.

In the formula (3), A and B more preferably bond to each other to form a ring structure. The ring structure formed is preferably a 5-, 6- or 7-membered non-aromatic heterocyclic ring having a total carbon atom number of 1-40, more preferably 3-30. Examples of the linked structure formed by A and B (-A-B—) include —O—(CH₂)₂—O—, —O—(CH₂)₃—O—, —S—(CH₂)₂—S—, —S—(CH₂)₃—S—, —S-Ph-S—, —N(CH₃)—(CH₂)₂—O—, —N(CH₃)—(CH₂)₂—S—, —O—(CH₂)₂—S—, —O—(CH₂)₃—S—, —N(CH₃)-Ph-O—, —N(CH₃)-Ph-S—, —N(Ph)-(CH₂)₂—S— and so forth. Ph represents a benzene ring.

Into the high contrast agent compounds represented by the formula (1), (2) or (3) used in the present invention, an adsorptive group capable of adsorbing to silver halide may be integrated. Examples of the adsorptive group include the groups described in U.S. Pat. Nos. 4,385,108, 4,459,347, JP-A-59-195233, JP-A-59-200231, JP-A-59-201045, JP-A-59-201046, JP-A-59-201047, JP-A-59-201048, JP-A-59-201049, JP-A-61-170733, JP-A-61-270744, JP-A-62-948, JP-A-63-234244, JP-A-63-234245 and JP-A-63-234246, such as an alkylthio group, an arylthio group, a thiourea group, a thioamido group, a mercaptoheterocyclic group and a triazole group. The adsorptive group to silver halide may be made into a precursor. Examples of the precursor include the groups described in JP-A-2-285344.

Into the compound represented by the formula (1), (2) or (3) used in the present invention, a ballast group or polymer commonly used in immobile photographic additives such as a coupler may be integrated, and preferably a ballast group is incorporated. The ballast group is a group having 8 or more carbon atoms and being relatively inactive to the photographic properties. The ballast group can be selected from an alkyl group, an aralkyl group, an alkoxy group, a phenyl group, an alkylphenyl group, a phenoxy group, an alkylphenoxy group and so forth. Examples of the polymer include those described in JP-A-1-100530.

The compound represented by the formula (1), (2) or (3) used in the present invention may contain a cationic group (specifically, a group containing a quaternary armonio group or a nitrogen-containing heterocyclic group containing a quaternized nitrogen atom), a group containing an ethyleneoxy group or a propyleneoxy group as a repeating unit, an (alkyl, aryl or heterocyclyl)thio group, or a dissociative group capable of dissociation with a base (e.g., carboxy group, sulfo group, acylsulfamoyl group, carbamoylsulfamoyl group etc.), preferably a group containing an ethyleneoxy group or a propyleneoxy group as a repeating unit, or an (alkyl, aryl or heterocyclyl)thio group. Specific examples of compound having these groups include the compounds described in JP-A-7-234471, JP-A-5-333466, JP-A-6-19032, JP-A-6-19031, JP-A-5-45761, U.S. Pat. Nos. 4,994,365, 4,988,604, JP-A-3-259240, JP-A-7-5610, JP-A-7-244348, German Patent No. 4,006,032 and so forth.

Specific examples of the compounds represented by the formulas (1) to (3) used in the present invention are shown below. However, compounds that can be used for the present invention are not limited to the following compounds.

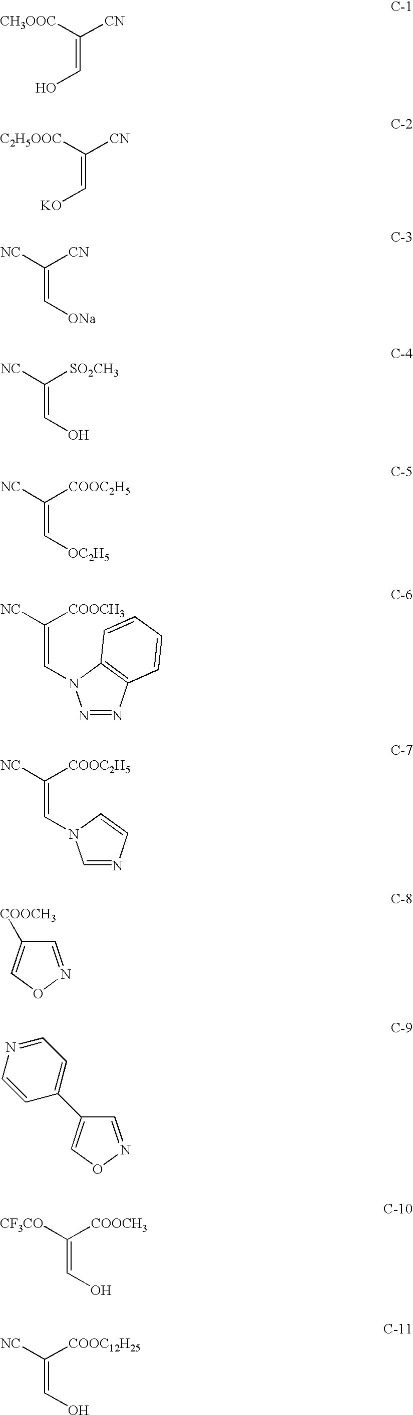

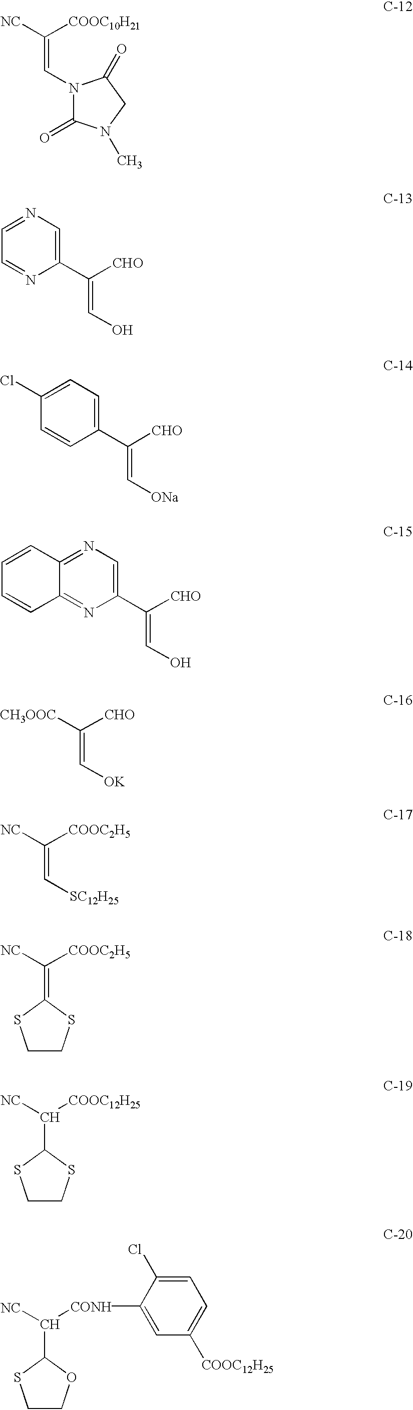

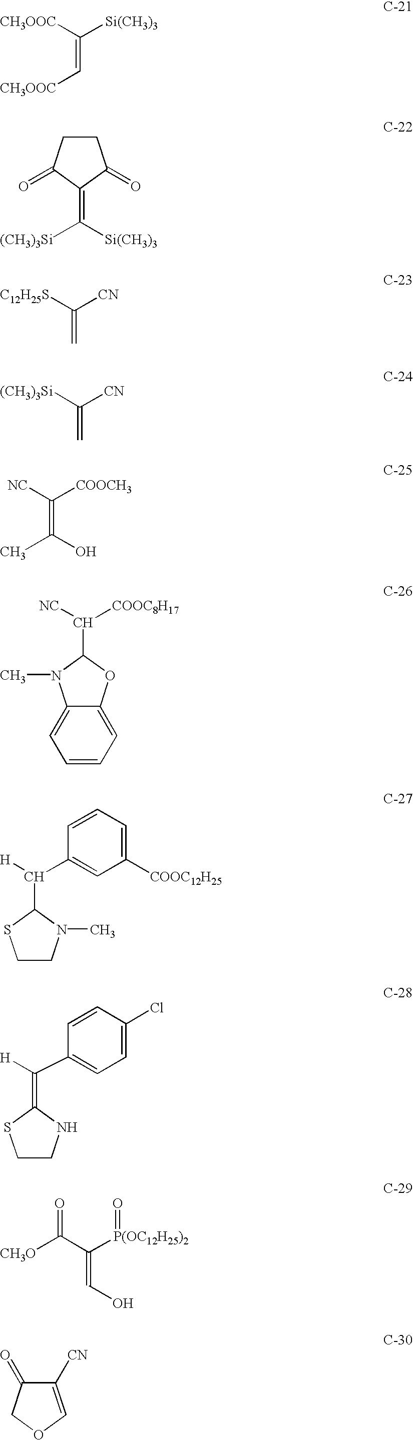

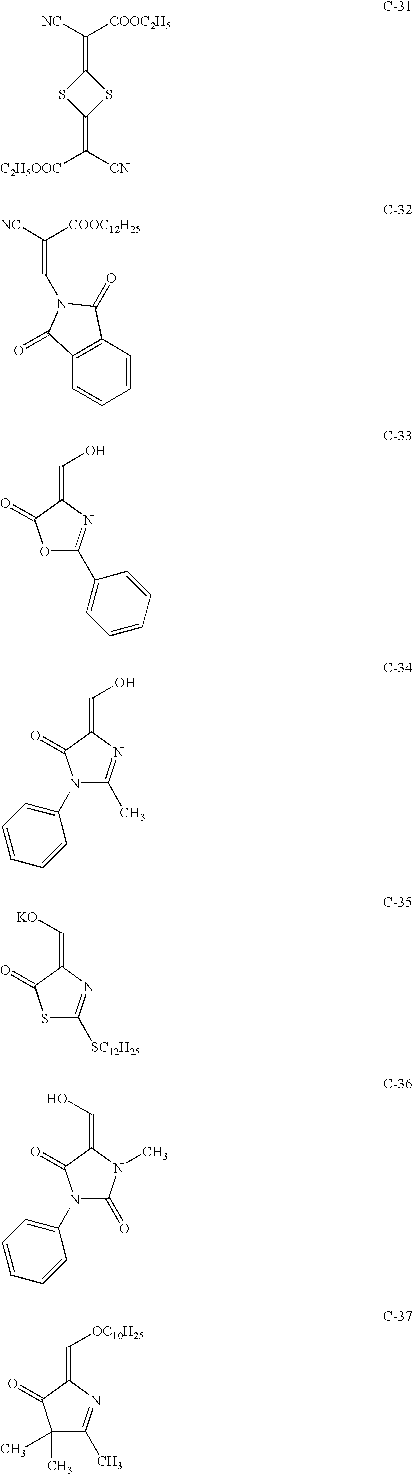

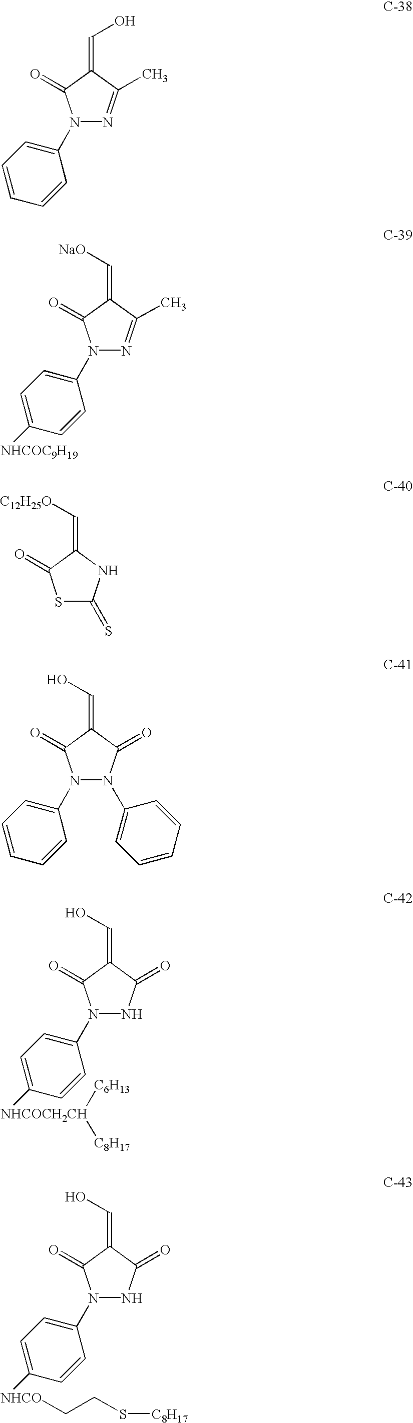

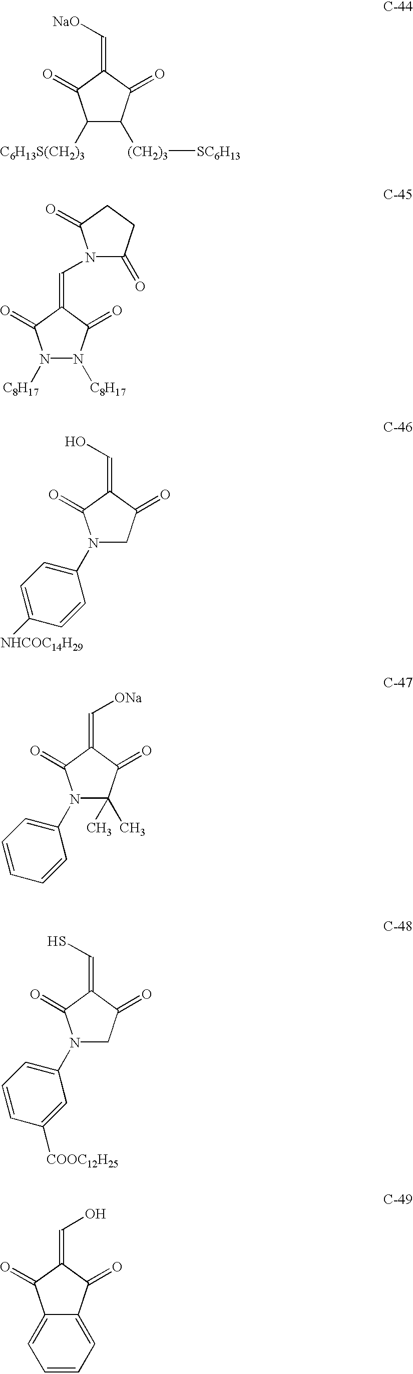

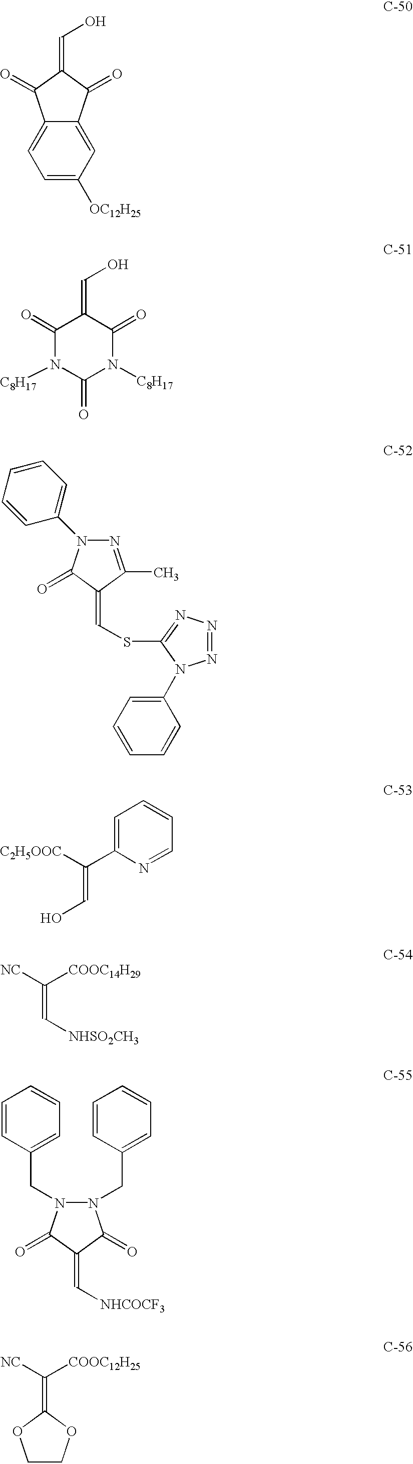

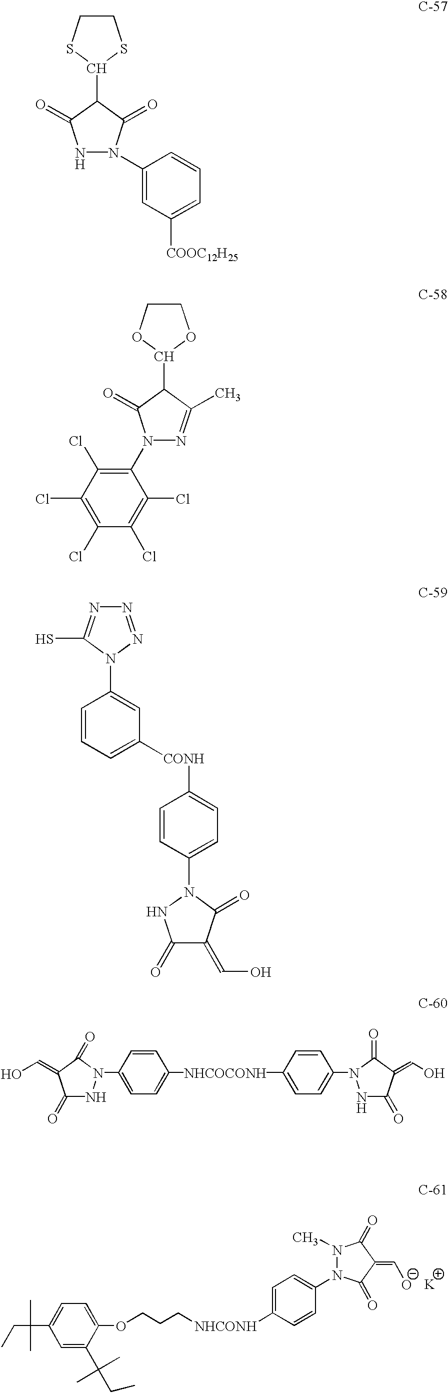

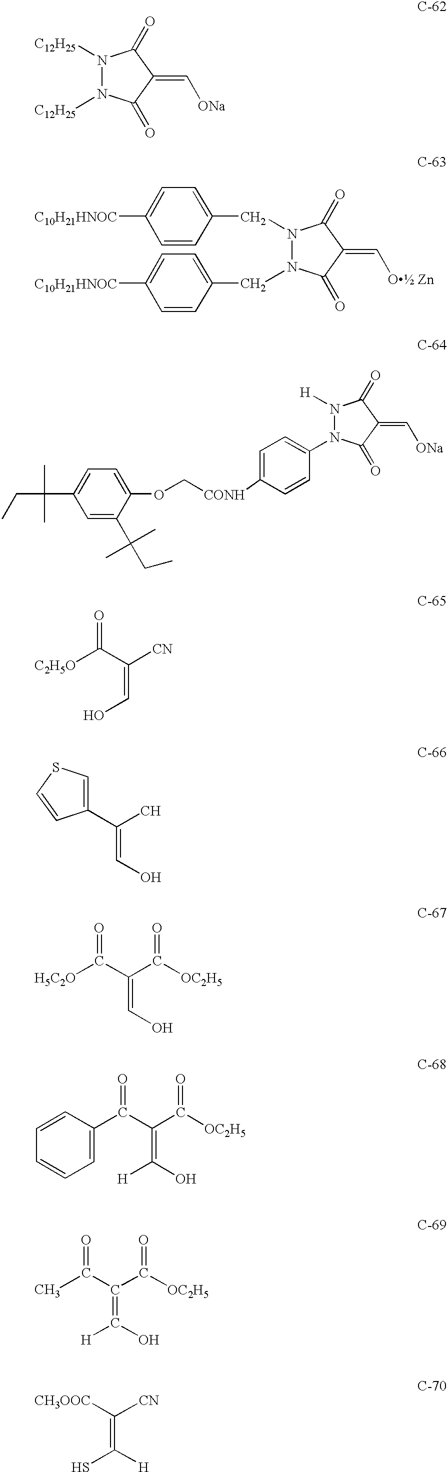

The high contrast agent compounds represented by the formulas (1) to (3) used in the present invention may be used after dissolving them in water or an appropriate organic solvent such as an alcohol (e.g., methanol, ethanol, propanol, fluorinated alcohol), a ketone (e.g., acetone, methyl ethyl ketone), dimethylformamide, dimethylsulfoxide or methyl cellosolve.

The compounds represented by the formulas (1) to (3) used for the present invention may be added to a layer in the image-forming layer side on the support, i.e., an image-forming layer or any other layers. However, the compounds are preferably added to an image-forming layer or a layer adjacent thereto.

The compounds represented by the formula (1), (2) or (3) used for the present invention are preferably added in an amount of from 1×10⁻⁶ to 1 mol, more preferably from 1×10⁻⁵ to 5×10⁻¹ mol, most preferably from 2×10⁻⁵ to 2×10⁻¹ mol, per mole of silver.

The compounds represented by formulas (1) to (3) can be easily synthesized according to known methods and may be synthesized by referring to, for example, U.S Pat. Nos. 5,545,515, 5,635,339, 5,654,130, International Patent Publication WO97/34196, JP-A-11-133546, JP-A-11-95365 and so forth.

The compounds represented by the formulas (1) to (3) may be used individually or in combination of two or more kinds of them. In addition to these compounds, the compounds described in U.S. Pat. Nos. 5,545,515, 5,635,339, 5,654,130, International Patent Publication WO97/34196, U.S. Pat. No. 5,686,228 and the compounds described in JP-A-11-119372, JP-A-11-133546, JP-A-11-119373, JP-A-11-109564, JP-A-11-95365, JP-A-11-95366 and JP-A-11-149136 may also be used in combination.

In the photothermographic material of the present invention, a hydrazine derivative may be used as the high contrast agent, and the aforementioned high contrast agent compounds may be used together with a hydrazine derivative. In such cases, the hydrazine derivatives described below are preferably used. The hydrazine derivatives used for the present invention can be synthesized by various methods described in the following patent publications.

Examples of the hydrazine derivative include the compounds mentioned in (Chemical Formula 1) of JP-B-6-77138, specifically, the compounds described at pages 3 and 4 of the same; the compounds represented by the formula (I) of JP-B-6-93082, specifically, Compounds 1-38 described at pages 8 to 18 of the same; the compounds represented by the formulas (4), (5) and (6) of JP-A-6-230497, specifically, Compounds 4-1 to 4-10 described at pages 25 and 26, Compounds 5-1 to 5-42 described at pages 28 to 36 and Compounds 6-1 to 6-7 described at pages 39 and 40 of the same; the compounds represented by the formulas (1) and (2) of JP-A-6-289520, specifically, Compounds 1-1) to 1-17) and 2-1) described at pages 5 to 7 of the same; the compounds mentioned in (Chemical Formula 2) and (Chemical Formula 3) of JP-A-6-313936, specifically, compounds described at pages 6 to 19 of the same; the compound mentioned in (Chemical Formula 1) of JP-A-6-313951, specifically, the compounds described at pages 3 to 5 of the same; the compound represented by the formula (I) of JP-A-7-5610, specifically, Compounds I-1 to I-38 described at pages 5 to 10 of the same; the compounds represented by the formula (II) of JP-A-7-77783, specifically, Compounds II-1 to II-102 described at pages 10 to 27 of the same; the compounds represented by the formulas (H) and (Ha) of JP-A-7-104426, specifically, Compounds H-1 to H-44 described at pages 8 to 15 of the same; the compounds characterized by having in the vicinity of the hydrazine group an anionic group or a nonionic group capable of forming an internal hydrogen bond with a hydrogen atom of hydrazine, described in JP-A-9-22082, in particular, the compounds represented by the formulas (A), (B), (C), (D), (E) and (F), specifically, Compounds N-1 to N-30 described in the same; the compound represented by the formula (1) described in JP-A-9-22082, specifically, Compounds D-1 to D-55 described in the same; various hydrazine derivatives described at pages 25 to 34 of Kochi Gijutsu (Known Techniques), pages 1 to 207, Aztech (issued on Mar. 22, 1991); and Compounds D-2 and D-39 described in JP-A-62-86354 (pages 6 and 7).

The hydrazine derivatives used for the present invention may be used after dissolving them in an appropriate organic solvent such as an alcohol (e.g., methanol, ethanol, propanol, fluorinated alcohol), a ketone (e.g., acetone, methyl ethyl ketone), dimethylformamide, dimethylsulfoxide or methyl cellosolve.

The hydrazine derivatives used for the present invention may be added to any layers on the image-forming layer side on the support, i.e., an image-forming layer or other binder layers. However, they are preferably added to an image-forming layer or a binder layer adjacent thereto.

The addition amount of the hydrazine derivatives used for the present invention is preferably from 1×10⁻⁶ to 1×10⁻² mol, more preferably from 1×10⁻⁵ to 5×10⁻³ mol, most preferably from 2×10⁻⁵ to 5×10⁻³ mol, per mol of silver.

In the present invention, a contrast accelerator may be used in combination with the above-described ultrahigh contrast agent so as to form an ultrahigh contrast image. Examples thereof include the amine compounds described in U.S. Pat. No. 5,545,505, specifically, AM-1 to AM-5; the hydroxamic acids described in U.S. Pat. No. 5,545,507, specifically, HA-1 to HA-11; the acrylonitriles described in U.S. Pat. No. 5,545,507, specifically, CN-1 to CN-13; the hydrazine compounds described in U.S. Pat. No. 5,558,983, specifically, CA-1 to CA-6; the onium salts described in JP-A-9-297368, specifically, A-1 to A-42, B-1 to B-27 and C-1 to C-14 and so forth.

The synthesis methods, addition methods and addition amounts of the aforementioned contrast accelerators may be according to those described in the patent publications cited above.

The photothermographic material of the present invention may contain an antifoggant. The antifoggant that is particularly preferably used in the present invention is an organic halide, and examples thereof include, for example, those compounds disclosed in U.S. Pat. Nos. 3,874,946, 4,756,999, 5,340,712, 5,369,000, 5,464,737, JP-A-50-120328, JP-A-50-137126, JP-A-50-89020, JP-A-50-119624, JP-A-59-57234, JP-A-7-2781, JP-A-7-5621, JP-A-9-160164, JP-A-9-160167, JP-A-10-197988, JP-A-9-244177, JP-A-9-244178, JP-A-9-160167, JP-A-9-319022, JP-A-9-258367, JP-A-9-265150, JP-A-9-319022, JP-A-10-197989, JP-A-11-242304, JP-A-2000-2963, JP-A-2000-112070, JP-A-2000-284412, JP-A-2000-284399, JP-A-2000-284410, JP-A-2001-33911, JP-A-2001-5144 and so forth. Among these, particularly preferred organic halides are 2-tribromomethylsulfonylquinoline described in JP-A-7-2781, 2-tribromomethylsulfonylpyridine described in JP-A-2001-5144, the compounds of P-1 to P-31 described in JP-A-2000-112070, the compounds of P-1 to P-73 described in JP-A-2000-284410, the compounds of P-1 to P-25 and P′-1 to P′-27 described in JP-A-2001-33911, the compounds of P-1 to P-118 described in JP-A-2000-284399, phenyltribromomethylsulfone and 2-naphthyltribromomethylsulfone.

The amount of the organic halides is preferably 1×10⁻⁵ mole to 2 moles/mole Ag, more preferably 5×10⁻⁵ mole to 1 mole/mole Ag, further preferably 1×10⁻⁴ mole to 5−10⁻¹ mole/mole Ag, in terms of molar amount per mole of Ag (mole/mole Ag). The organic halides may be used each alone, or two or more of them may be used in combination.

A binder suitable for the photothermographic material of the present invention is preferably a transparent or translucent and generally colorless polymer, and examples thereof include natural polymers, synthetic resins, synthetic homopolymers and copolymers and other film-forming media. Specific examples thereof include, for example, gelatin, gum arabic, poly(vinyl alcohol), hydroxyethylcellulose, cellulose acetate, cellulose acetatebutyrate, poly(vinylpyrrolidone), casein, starch, poly(acrylic acid), poly(methyl methacrylate), poly(vinyl chloride), poly(methacrylic acid), copoly(styrene-maleic anhydride), copoly(styrene-acrylo-nitrile), copoly(styrene-butadiene), poly(vinyl acetal) (e.g., poly(vinyl formal), poly(vinyl butyral)), poly(ester), poly(urethane), phenoxy resin, poly(vinylidene chloride), poly(epoxide), poly(carbonate), poly(vinyl acetate), cellulose ester, poly(amide) and so forth. Although the binder may be hydrophilic or hydrophobic, it is preferable to use a hydrophobic transparent binder in order to reduce fog after heat development. Preferred binders are polyvinyl butyral, cellulose acetate, cellulose acetate butyrate, polyester, polycarbonate, polyacrylic acid, polyurethane and so forth. Among these, polyvinyl butyral, cellulose acetate, cellulose acetate butyrate and polyester are particularly preferably used.

The photothermographic material of the present invention has a non-photosensitive layer on one side of the image-forming layer remoter from the support, i.e., on the image-forming layer. The non-photosensitive layer has a thickness of 2.8-8 μm, preferably 3-8 μm, more preferably 3.5-7 μm. The binder used for this non-photosensitive layer is preferably cellulose acetate or cellulose acetate butyrate, particularly preferably cellulose acetatebutyrate. The amount of the binder in the non-photosensitive layer may be such an amount that the thickness of the non-photosensitive layer should be in the range of 2.8-8 μm, specifically 2.6-10 g/m², preferably 3-9 g/m².

In the present invention, in order to increase the heat development speed, the amount of the binder in the image-forming layer is preferably 1.5-10 g/m², more preferably 1.7-8 g/m². If the amount is less than 1.5 g/m², density of unexposed area increases markedly, and it may not be used.

The photothermographic material of the present invention preferably contains a matting agent on the image-forming layer side. In order to prevent scratches on images after heat development, the matting agent is preferably contained in a surface layer of the photothermographic material, i.e., the non-photosensitive layer, and the matting agent is preferably contained in an amount of 0.5-30% by weight of the total amount of the binder on the image-forming layer side. Further, when a back layer is provided on the side opposite to the image-forming layer with respect to the support, at least one layer on the back layer side preferably contains a matting agent, and the matting agent is preferably contained in a surface layer also in view of lubricity of the photothermographic material or prevention of adhesion of fingerprints. The matting agent is preferably contained in an amount of 0.5-40% by weight of the total amount of the binder of the back layer on the side opposite to the image-forming layer side. While the matting agent may have a regular form or irregular form, it preferably has a regular form, and a spherical form is preferably used.

As the matting agent of the non-photosensitive layer, silica is preferably used. The silica matting agent should have a mean particle size of 0.5 μm or less, preferably 0.5-3.5 μm. The variation coefficient for particle size is preferably 3-50%, more preferably 3-30%. The variation coefficient for particle size distribution means a value calculated in accordance with the following equation. Variation coefficient={(Standard deviation of particle size)/(Average of particle size)}×100

In order to control quantity or wavelength distribution of light transmitting the image-forming layer, a filter dye layer may be provided on the same side as the image-forming layer and/or an antihalation dye layer, a so-called backing layer, may be provided on the opposite side, and a dye or pigment may be added to the image-forming layer. The optionally formed non-photosensitive layer preferably contains the binder or the matting agent, and may further contain a lubricant such as polysiloxane compounds, wax and liquid paraffin.

Further, various surfactants can be used as coating aids for the photothermographic material. Inter alia, fluorine-containing surfactants are preferably used to improve electrification characteristics or to prevent spot-like coating failures.

The photothermographic material may contain a toning agent for suppressing silver color tone, if needed. Preferred examples of the toning agent are disclosed in Research Disclosure, No. 17029.

Various additives may be added to any of the image-forming layer, non-photosensitive layer and other layers to be formed. For the photothermographic material, there can be used, for example, surfactant, antioxidant, stabilizer, plasticizer, ultraviolet absorber, coating aid and so forth. As these additives and the other additives mentioned above, the compounds disclosed in Research Disclosure, No. 17029 (p.9-15, June, 1978) can be preferably used.

The support of the photothermographic material is preferably transparent, and it is preferably a support of a film of plastic (e.g., polyethylene terephthalate, polycarbonate, polyimide, nylon, cellulose triacetate, polyethylene naphthalate) in order to obtain a predetermined optical density after the development and to prevent deformation of images after the development. A support of polyethylene terephthalate (abbreviated as “PET” hereinafter) or plastics containing styrene type polymer having a syndiotactic structure (abbreviated as “SPS” hereinafter) is particularly preferred. The support suitably has a thickness of about 50-300 μm, preferably 70-180 μm. A plastic support subjected to a heat treatment may also be used. The plastics to be employed for this purpose may be any of the plastics mentioned above. As for the heat treatment of the support, a support may be heated at a temperature higher than the glass transition temperature of the support by 30° C. or more, preferably 35° C. or more, still more preferably 40° C. or more, but not exceeding the melting point of the support, after the formation of the support as a film and before coating of the image-forming layer.

In order to improve electrification property of the photothermographic material, conductive compounds such as metal oxides and/or conductive polymers can be added to a constitutive layer. Although they may be added to any layer, they are preferably added to an undercoat layer, back layer, layer between the image-forming layer and an undercoat layer or the like. The conductive compounds disclosed in U.S. Pat. No.5,244,773, columns 14-20 can be preferably used in the present invention.

Hereafter, structure of the photothermographic material of the present invention will be explained.

The photothermographic material of the present invention can be produced by coating a silver halide, a silver salt of an organic acid, a reducing agent and a high contrast agent on a support. The photothermographic material preferably has a structure that at least one image-forming layer containing the silver halide, silver salt of an organic acid, reducing agent and high contrast agent is provided on the support. Further, the photothermographic material may have, besides the image-forming layer, a non-photosensitive layer such as a protective layer, undercoat layer and filter layer, and the filter layer may be provided on either the image forming layer side or the side opposite to the image forming layer side. As described above, one of the layers is a coated layer formed by applying a coating solution containing 30 weight % or more of an organic solvent, and it is preferred that the image-forming layer should be the coated layer formed by applying a coating solution containing 30 weight % or more of an organic solvent. The organic solvent is preferably contained in the coating solution in an amount of 30-90 weigh %, more preferably 30-80 weight %. The organic solvent is not particularly limited, and a single solvent or two or more solvents may be used. Preferred examples of the organic solvent include ketones such as acetone, methyl ethyl ketone and methyl isobutyl ketone, alcohols such as methanol, ethanol, propanol, butanol and phenol, aromatic hydrocarbons such as benzene, toluene and xylene, aliphatic hydrocarbons such as pentane, hexane, octane, nonane and cyclohexane, ethers, halogenated hydrocarbons such as carbon tetrachlorides, dichloromethane and dichloroethane. The coating solution may contain water. However, when it contains water, the amount of water is preferably 20 weight % or less, more preferably 10 weight % or less.

In the photothermographic material of the present invention, the total amount of the residual organic solvent of the constitutive layers after the coating and heating is preferably 5-300 mg, more preferably 5-150 mg, per 1 m² of the photothermographic material. If the amount of residual organic solvent is in these ranges, the loading of image line widths becomes little and good result of density unevenness can be obtained even with heat development under a highly humid environment, which are the purposes of the present invention. On the other hand, if the amount of residual organic solvent is 5 mg or less per 1 m² of the photothermographic material, there is caused a problem that a sufficient density cannot be obtained.

As for the method of measuring content of the solvent in the photothermographic material, a piece of an objective photosensitive material is cut out for a certain area, and the area of the piece is measured correctly. This piece is minced finely, introduced into a special vial and sealed. This vial can be on a head space sampler (HP7694, Hewlett Packard), heated to a predetermined temperature and introduced into a gas chromatography apparatus to measure the content by measuring a peak area of the objective solvent. Since all the organic solvent contained in the photothermographic material cannot be extracted by a single injection, the injection of the same sample is repeated several times and measurement is attained by totalizing the values measured for the multiple injections.

Hereafter, the image formation method utilizing the photothermographic material will be explained in detail. First, the photothermographic material is preferably exposed with a light having a wavelength of 750-800 nm. As a light exposure apparatus used for the light exposure, any light source may be used so long as it can enables light exposure with an exposure time of 10-7 second or shorter, a light exposure apparatus utilizing a laser diode (LD) or light emission diode (LED) as a light source is generally preferably used. In particular, LD is more preferred in view of high output and high resolution. Any light source may be used so long as it can emit a light of electromagnetic wave spectrum of desired wavelength range. For example, as for LD, dye lasers, gas lasers, solid state lasers, semiconductor lasers and so forth can be used.

For use in printing, density of non-image areas is preferably low from the UV region to the visible region, and a material sensitive to a light of 700-850 nm is required.

In the image formation method used for the photothermographic material of the present invention, the photothermographic material is preferably exposed with overlapped light beams of light sources. The term “overlapped” means that a vertical scanning pitch width is smaller than the diameter of the beams. For example, the overlap can be quantitatively expressed as FWHM/vertical-scanning pitch width (overlap coefficient), where the beam diameter is represented as a half width of beam strength (FWHM). In the present invention, it is preferred that this overlap coefficient should be 0.2 or more.

The scanning method of the light source of the light exposure apparatus used in the present invention is not particularly limited, and the cylinder external surface scanning method, cylinder internal surface scanning method, flat surface scanning method and so forth can be used. Although the channel of light source may be either single channel or multichannel, a multichannel comprising two or more of laser heads is preferred, because it provides high output and shortens writing time. In particular, for the cylinder external surface scanning method, a multichannel carrying several to several tens or more of laser heads is preferably used.

The scanning method of the light source of the light exposure apparatus preferably used for the present invention is the inner drum method (cylinder internal surface scanning method). The light exposure is attained by scanning the surface of the photothermographic material transported into the inner drum section with a laser light emitted from a laser diode and reflected by a polygon mirror (prism). The exposure time for the main scanning direction is determined by the rotation number of the polygon mirror and the inner diameter of the drum. The main scanning speed on the surface of the photothermographic material of the present invention is preferably 500-1500 m/second, more preferably 1100-1500 m/second.

If a photothermographic material to be exposed shows low haze upon light exposure, it is likely to generate interference fringes and therefore it is preferably to prevent it. As techniques for preventing such interference fringes, there are known a technique of obliquely irradiating a photosensitive material with a laser light as disclosed in JP-A-5-113548, a technique of utilizing a multimode laser as disclosed in WO95/31754 and so forth, and these techniques are preferably used.

In the image formation method used for the present invention, the photothermographic material is light-exposed to form a latent image, and then subjected to development in a development apparatus equipped with a preheating section, a heat development section and a gradual cooling section. The development temperature in the development apparatus is preferably 80-250° C., more preferably 100-140° C. The development time in the development apparatus is preferably 1-180 seconds, more preferably 5-90 seconds, in total. Further, the heat development speed in the heat development section in the heat development apparatus is preferably 20-200 mm/second, more preferably 25-200 mm/second.

The light-exposed photothermographic material is first heated in the preheating section. The preheating section is provided in order to prevent uneven development caused by dimensional change of the photothermographic material during the heat development. As for the heating in the preheating section, temperature is desirably controlled to be lower than the heat development temperature (for example, lower by about 10-30° C.), and the temperature and time in this section are desirably adjusted so that they can be sufficient for evaporating moisture remaining in the photothermographic material. The temperature is also preferably adjusted to be higher than the glass transition temperature (Tg) of the support of the photothermographic material so that uneven development can be prevented. It is generally preferred that the photothermographic material should be heated at a temperature of 80° C. or higher but lower than 115° C. for 5 seconds or more.

The photothermographic material heated in the preheating section is subsequently heated in the heat development section. In the image formation method of the present invention, the heat development section is provided with heating members on image-forming layer side and back layer side and transportation rollers only on the image-forming layer side with respect to the photothermographic material to be transported. For example, when the photothermographic material is transported so that it can have the image-forming layer on the upper side, there is employed a configuration that no transportation rollers are provided on the lower side of the photothermographic material (back layer side of the photothermographic material) and transportation rollers are provided only on the upper side (image-forming layer side of the photothermographic material) with respect to the transportation plane of the photothermographic material. In the present invention, generation of density unevenness and physical deformation are prevented by employing the above configuration of the heat development section.

In the heat development section, the photothermographic material is heated by heating members such as heaters. The heating temperature in the heat development section is a temperature sufficient for the heat development, and it is generally 110-140° C. Since the photothermographic material is subjected to a high temperature of 110° C. or higher in the heat development section, a part of the components contained in the material or a part of decomposition products produced by the heat development may be volatilized. It is known that these volatilized components invite various bad influences, for example, they may cause uneven development, erode structural members of development apparatuses, deposit at low temperature portions as dusts to cause deformation of image surface, adhere to image surface as stains and so forth. As a method for eliminating these influences, it is known to provide a filter on the heat development apparatus, or suitably control air flows in the heat development apparatus. These methods may be effectively used in combination. For example, WO95/30933, WO97/21150 and International Patent Publication in Japanese (Kohyo) No. 10-500496 disclose use of a filter cartridge containing binding absorption particles and having a first vent for taking up volatilized components and a second vent for discharging them in a heating apparatus for heating a film by contact. Further, WO96/12213 and International Patent Publication in Japanese (Kohyo) No. 10-507403 disclose use of a filter consisting of a combination of heat conductive condensation collector and a gas-absorptive microparticle filter. These can be preferably used in the present invention. Further, U.S. Pat. No. 4,518,845 and JP-B-3-54331 disclose structures comprising means for eliminating vapor from a film, pressing means for pressing a film to a heat-conductive member and means for heating the heat-conductive member. Furthermore, WO98/27458 discloses elimination of components volatilized from a film and increasing fog from a surface of the film. These techniques are also preferably used for the present invention.

Temperature distribution in the preheating section and the heat development section is preferably in the range of ±1° C. or less, more preferably ±0.5° C. or less, respectively.

The photothermographic material heated in the heat development section is then cooled in the gradual cooling section. It is preferred that the cooling should be gradually attained so that the photothermographic material can not physically deform, and the cooling rate is preferably 0.5-10° C./second.

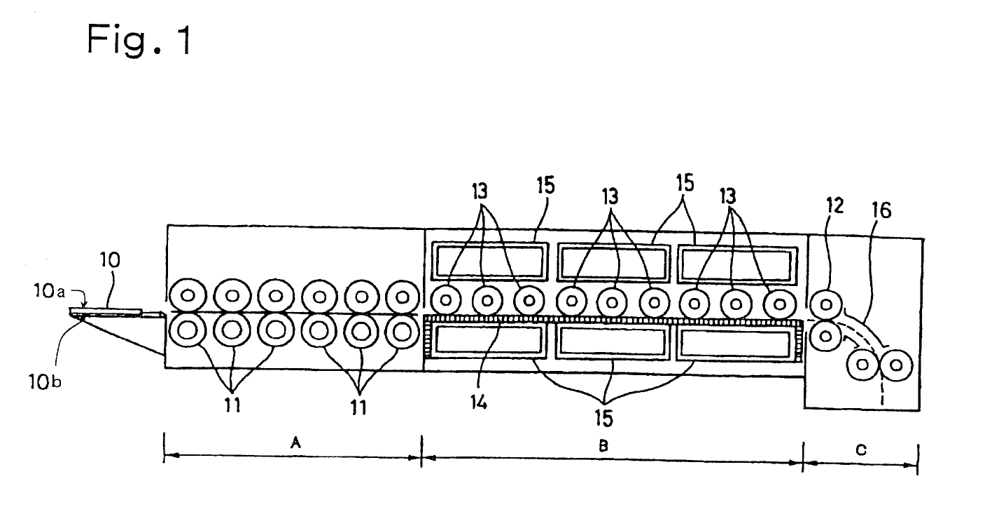

An exemplary structure of heat development apparatus used for the image formation method of the present invention is shown in FIG. 1.

FIG. 1 depicts a schematic side view of a heat development apparatus. The heat development apparatus shown in FIG. 1 consists of a preheating section A for preheating a photothermographic material 10, a heat development section B for carrying out the heat development, and a gradual cooling section C for cooling the photothermographic material. The preheating section A comprises taking-in roller pairs 11 (upper rollers are silicone rubber rollers, and lower rollers are aluminum heating rollers). The Heat development section B is provided with multiple rollers 13 on the side contacting with the surface 10a of the photothermographic material 10 on which the image-forming layer is formed, and a flat surface 14 adhered with non-woven fabric (composed of, for example, aromatic polyamide, Teflon™ etc.) or the like on the opposite side to be contacted with the back layer side surface 10b of the photothermographic material 10. The clearance between the rollers 13 and the flat surface 14 is suitably adjusted to a clearance that allows the transportation of the photothermographic material 10. The clearance is generally about 0-1 mm. In the heat development section B, heaters 15 (panel heaters etc.) are further provided over the rollers 13 and under the flat surface 14 so as to heat the photothermographic material 10 from the image-forming layer side and the back layer side. The gradual cooling section C is provided with taking-out roller pairs 12 for taking out the photothermographic material 10 from the heat development section B and guide panels 16.

The photothermographic material 10 is subjected to heat development while it is transported by the taking-in roller pairs 11 and then by the taking-out roller pairs 12.

After the light exposure, the photothermographic material 10 is carried into the preheating section A. In the preheating section A, the photothermographic material 10 is made into a flat shape, preheated and then transported into the heat development section B by the multiple taking-in rollers 12. The photothermographic material 10 carried into the heat development section B is inserted into the clearance between the multiple rollers 13 and the flat surface 14 and transported by driving of the rollers 13 contacting with the surface 10a of the photothermographic material 10, while the back layer side surface 10b slides on the flat surface 14. During the transportation, the photothermographic material 10 is heated to a temperature sufficient for the heat development by the heaters 15 from both of the image-forming layer side and the back layer side so that the latent image formed by the light exposure is developed. Then, the photothermographic material 10 is transported into the gradual cooling section C, and made into a flat shape and taken out from the heat development apparatus 20 by the taking-out roller pairs 12.

The materials of the surfaces of the rollers 13 and the member of the flat surface 14 in the heat development section B may be composed of any materials so long as they have heat resistance and they should not cause any troubles in the transportation of the photothermographic material 10. However, the material of surfaces of the rollers 13 is preferably composed of silicone rubber, and the member of the flat surface 14 is preferably composed of non-woven fabric made of aromatic polyamide or Teflon (PTFE). Shape and number of the heaters 15 are not particularly limited so long as they can heat the photothermographic material 10 to a temperature sufficient for the heat development of the material. However, they preferably have such a configuration that heating temperature of each heater can be adjusted freely.

The photothermographic material 10 is heated in the preheating section A comprising the taking-in roller pairs 11 and the heat development section B comprising the heaters 15. Temperature of the preheating section A is preferably controlled to be lower than the heat development temperature (for example, lower by about 10-30° C.), and the temperature and time in this section are desirably adjusted so that they can be sufficient for evaporating solvent contained in the photothermographic material 10. The temperature is also preferably adjusted to be higher than the glass transition temperature (Tg) of the support of the photothermographic material 10 so that uneven development can be prevented. Temperature distribution in the preheating section and the heat development section is preferably in the range of ±1° C. or less, more preferably ±0.5° C. or less.

In the gradual cooling section C, in order to prevent deformation of the photothermographic material 10 due to rapid cooling, the guide panels 16 are preferably composed of a material showing low heat conductivity.

The photothermographic material of the present invention is preferably exposed and heat-developed by an on-line system comprising a plotter, an auto carrier and a heat development apparatus. The auto carrier automatically transports the exposed photothermographic material to a processor (heat development apparatus). Although the transportation mechanism may be based on any of belt conveyor, roller transportation and so forth, roller transportation is preferred. Further, in the auto carrier, there is preferably provided a mechanism for preventing a heat flow from the heat development apparatus side to the plotter side, and for example, a method of blowing a wind to the plotter and the heat development apparatus from a lower position at the center of the auto carrier can be mentioned.

The development is preferably performed with such conditions that the line speed ratio of the preheating section and the heat development section should become 95.0-99.0% and the line speed ratio of the auto carrier and the preheating section should become 90.0-100.0%. If the line speed ratio of the preheating section and the heat development section is less than 95.0% and/or the line speed ratio of the auto carrier and the preheating section is less than 90.0%, scratches or jamming may be caused to degrade the transportability, and it becomes likely that density unevenness is unfavorably generated.

### EXAMPLES

The present invention will be further specifically explained with reference to the following examples. The materials, regents, ratios, procedures and so forth shown in the following examples can be optionally changed so long as such change does not depart from the spirit of the present invention. Therefore, the scope of the present invention is not limited by the following examples.

### Example 1

1) Preparation of Undercoated Support

An undercoated polyethylene terephthalate (henceforth abbreviated as “PET”) support was prepared as follows.

A commercially available biaxially stretched and thermally fixed PET film having a thickness of 130 μm was subjected to a corona discharge treatment of 8 W/m²·minute for the both surfaces. On one surface of the support, Undercoat coating solution a-1 mentioned below was coated in such an amount that a dry film thickness of 0.8 μm should be obtained and dried to form Undercoat layer A-1, and on the opposite surface, Undercoat coating solution b-1 mentioned below containing an antistatic component was applied in such an amount that a dry film thickness of 0.8 μm should be obtained and dried to form Undercoat layer B-1 having antistatic property.

<<Undercoat coating solution a-1>>

| | | |
|---|---|---|
| Copolymer latex solution | 270.0 | g |
| (solid content: 30%, butyl acrylate/ | | |
| tert-butyl acrylate/styrene/ | | |
| 2-hydroxyethyl acrylate = | | |
| 30/20/25/25 (weight %)) | | |
| (C-1) mentioned below | 0.6 | g |
| Hexamethylene-1,6-bis(ethyleneurea) | 0.8 | g |
| Polystyrene microparticles | 0.05 | g |
| (mean particle size: 3 μm) | | |
| Colloidal silica | 0.1 | g |
| (mean particle size: 90 μm) | | |

| | |
|---|---|
| Water | Amount to make a total |
| | volume of 1000 mL |

<<Undercoat coating solution b-1>>

| SnO₂/Sb (weight ratio: 9/1, | Amount giving | |
|---|---|---|
| mean particle size: 0.18 μm) | coating amount of | |
| | 200 | mg/m² |
| Copolymer latex solution | 270.0 | g |
| (solid content: 30%, butyl acrylate/ | | |
| styrene/glycidyl acrylate = | | |
| 40/20/40 (weight %) | | |
| (C-1) mentioned below | 0.6 | g |
| Hexamethylene-1,6-bis(ethyleneurea) | 0.8 | g |

| | |
|---|---|
| Water | Amount to make a total |
| | volume of 1000 mL |

The surfaces of Undercoat layer A-1 and Undercoat layer B-1 were subjected to a corona discharge treatment of 8 W/m²·minute. On Undercoat layer A-1, Upper undercoat coating solution a-2 mentioned below was coated in such an amount that a dry film thickness of 0.1 μm should be obtained to form Upper undercoat layer A-2, and on Undercoat layer B-1, Upper undercoat coating solution b-2 mentioned below was applied in such an amount that a dry film thickness of 0.8 μm should be obtained to form Upper undercoat layer B-2 having antistatic property.

<<Upper undercoat coating solution a-2>>

| | |
|---|---|
| Gelatin | Amount giving |
| | coated amount of |
| | 0.4 g/m² |

| | | |
|---|---|---|
| (C-1) mentioned below | 0.2 | g |
| (C-2) mentioned below | 0.2 | g |
| (C-3) mentioned below | 0.1 | g |
| Silica particles | 0.1 | g |
| (mean particle size: 3 μm) | | |

| | |
|---|---|
| Water | Amount to make a total |
| | volume of 1000 mL |

<<Upper undercoat coating solution b-2>>

| | | |
|---|---|---|
| (C-4) mentioned below | 60 | g |
| Latex solution containing (C-5) | 80 | g |
| mentioned below (solid content: 20%) | | |
| Ammonium sulfate | 0.5 | g |
| (C-6) mentioned below | 12 | g |
| Polyethylene glycol | 6 | g |
| (weight average molecular weight: 600) | | |

| | |
|---|---|
| Water | Amount to make a total |
| | volume of 1000 mL |

(C-1)

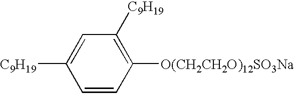

(C-2)

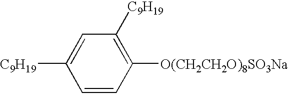

(C-3)

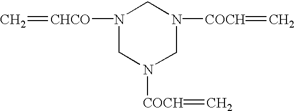

(C-4)

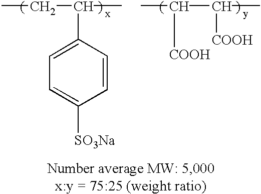

(C-5)

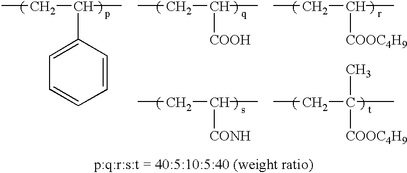

(C-6)
Mixture of the following three compounds

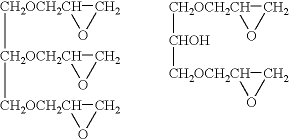

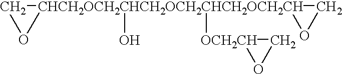

<<Heat Treatment of Support>>

The aforementioned undercoated support was transported at a tension of 2 kg/cm² and a transportation speed of 20 m/minute in a heat treatment zone set at 160° C. and having a total length of 200 m. Then, it was passed through a zone at 40° C. over 15 seconds and rolled up with a rolling up tension of 10 kg/cm².

2) Preparation of Emulsions and Solutions

<<Preparation of Silver Halide Emulsion A>>

In an amount of 7.5 g of inert gelatin and 10 mg of potassium bromide were dissolved in 900 mL of water, and the solution was adjusted to a temperature of 35° C. and pH 3.0, and added with 370 mL of an aqueous solution containing 74 g of silver nitrate and 370 mL of an aqueous solution containing sodium chloride, potassium bromide, potassium iodide in a molar ratio of 60/38/2, [Ir(NO)Cl₅] salt in an amount of 1×10⁻⁵ mole per mole of silver, iridium chloride salt in an amount of 1×10⁻⁵ mole per mole of silver and rhodium chloride salt in an amount of 1×10⁻⁶ mole per mole of silver by the controlled double jet method, while the pAg was kept at 7.7. Then, the solution was added with 4-hydroxy-6-methyl-1,3,3a,7-tetrazaindene and adjusted to pH 8.0 with NaOH and pAg 6.5 to perform reduction sensitization. Thus, cubic silver iodobromide grains having a mean grain size of 0.06 μm, monodispersion degree of 10%, variation coefficient of 8% for diameter of projected area as circle and [100] face ratio of 79%. This emulsion was added with a gelatin coagulant to cause coagulation precipitation for desalting, then added with 0.1 g of phenoxyethanol and adjusted to pH 5.9 and pAg 7.5 to obtain a silver halide emulsion.

<<Preparation of Sodium Behenate Solution>>

In an amount of 32.4 g of behenic acid, 9.9 g of arachidic acid and 5.6 g of stearic acid were dissolved in 945 mL of pure water at 90° C. Then, the solution was added with 98 mL of 1.5 mol/L sodium hydroxide aqueous solution with stirring at high speed. Subsequently, the solution was added with 0.93 mL of concentrated nitric acid, cooled to 55° C. and stirred for 30 minutes to obtain a sodium behenate solution.

<<Preparation of Preform Emulsion of Silver Behenate and Silver Halide Emulsion>>

The aforementioned sodium behenate solution was added with the silver halide emulsion mentioned above, adjusted to pH 8.1 with a sodium hydroxide solution, then added with 147 mL of 1 mol/L silver nitrate solution over 7 minutes, and stirred for 20 minutes, and water-soluble salts were removed by ultrafiltration. The produced silver behenate was in the form of grains having a mean grain size of 0.8 μm and monodispersion degree of 8%. After flocculates of the dispersion was formed, water was removed and the residue was subjected to 6 times of washing with water and removal of water and dried to obtain a preform emulsion.

<<Preparation of Photosensitive Emulsion A>>

The aforementioned preform emulsion was divided into portions and gradually added with 544 g of a solution of polyvinyl butyral (average molecular weight: 3,000) in methyl ethyl ketone (17 weight %) and 107 g of toluene, mixed and then dispersed at 30° C. for 10 minutes in a media dispersing machine utilizing a bead mill containing ZrO₂ having a size of 0.5 mm at 4000 psi to prepare a photosensitive emulsion. After the dispersion, the organic silver grains were examined by electron microphotography. As a result of measurement of grain size and thickness of 300 organic silver grains, it was found that 205 or more of the grains were monodispersed tabular organic silver grains having AR of 3 or more and dispersion degree of 25%. Themean grain size was 0.7 μm. Moreover, the organic silver grains were examined also after coating and drying, and the same grains could be confirmed.

3) Coating of Back Surface Side

A coating solution for back layer having the following composition was applied on Undercoat layer B-2 having antistatic property of the support by using an extrusion coater with a wet film thickness of 30 μm, and dried at 60° C. for 15 minutes.

<<Composition 1 for coating solution for back layer>>

| | | |
|---|---|---|
| Cellulose acetate butyrate | 15 | mL/m² |
| (10% solution in methyl ethyl ketone) | | |
| Dye A mentioned below | 30 | mg/m² |
| Matting agent (monodispersed silica, | 15 | mg/m² |
| monodispersion degree: 15%, | | |
| mean particle size: 8 μm) | | |
| C₈F₁₇(CH₂CH₂O)₁₂C₈F₁₇ | 50 | mg/m² |
| C₉F₁₉—C₆H₄—SO₃Na | 10 | mg/m² |

Dye A

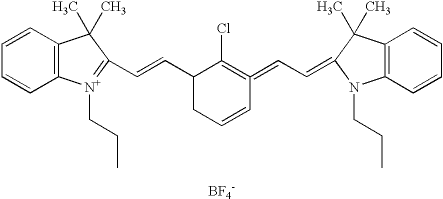

4) Coating of Image-Forming Layer Side

A coating solution for image-forming layer having the following composition (the solvent contained methyl ethyl ketone as a main component and contained 75 weight % of organic solvent) and a coating solution for non-photosensitive layer on the image-forming layer were coated simultaneously as stacked layers at a speed of 20 m/minute on Undercoat layer A-2 of the support by using an extrusion coater. The coating was performed so that the coated silver amount could become 2.0 g/m². Then, the coated layers were dried at 60° C. for 15 minutes.

<<Coating solution for image-forming layer

| | | |
|---|---|---|
| Photosensitive emulsion A mentioned above | 240 | g |
| Sensitizing dye A mentioned below | 1.7 | mL |
| (0.1% methanol solution) | | |
| Pyridinium perbromide | 3 | mL |
| (6% methanol solution) | | |
| Calcium bromide | 1.7 | mL |
| (0.1% methanol solution) | | |
| 2,4-Dichlorobenzoyl benzoate | 9 | mL |
| (12% methanol solution) | | |
| 2-Mercaptobenzimidazole | 11 | mL |
| (1% methanol solution) | | |
| Tribromomethylsulfoquinoline | 7 | mL |
| (5% methanol solution) | | |
| High contrast agent | 0.3 | g |
| (type is mentioned in Table 1) | | |
| Phthalazine | 0.6 | g |
| 4-Methylphthalic acid | 0.25 | g |
| Tetrachlorophthalic acid | 0.2 | g |
| Calcium carbonate | 0.1 | g |
| (mean particle size: 3 μm) | | |
| 1,1-Bis(2-hydroxy-3,5-dimethylphenyl)- | 2.5 | mL |
| 2-methylpropane | | |
| (20% methanol solution) | | |
| 1,1-Bis(2-hydroxy-3,5-dimethylphenyl)- | 15.5 | mL |
| 3,5,5-trimethylhexane | | |
| (20% methanol solution) | | |
| Isocyanate compound | 0.5 | g |
| (Desmodur N3300, Mobay) | | |
| Sensitizing dye A | | |

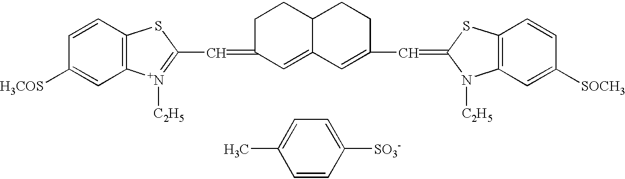

<<Coating solution for non-photosensitive layer>>

| Acetone | 5 | mL/m² |
|---|---|---|
| Methyl ethyl ketone | 21 | mL/m² |
| Cellulose acetate butyrate | Amount giving | |
| | dry thickness | |
| | mentioned in | |
| | Table 1 | |
| Methanol | 7 | mL/m² |
| Phthalazine | 250 | mg/m² |
| Silica matting agent | | |
| (monodispersion degree, | | |
| mean particle size and coated amount | | |
| are mentioned in Table 1) | | |
| CH₂═CHSO₂CH₂CONHCH₂CH₂NHCOCH₂SO₂CH═CH₂ | 35 | mg/m² |
| Fluorine-containing surfactants | | |
| C₁₂F₂₅(CH₂CH₂O)₁₀C₁₂F₂₅ | 10 | mg/m² |
| C₈F₁₇—C₆H₄—SO₃Na | 10 | mg/m² |

5) Light Exposure

Each of the produced photothermographic materials was made into a sheet having a width of 590 mm and a length of 59 m and rolled around a cylindrical core member so that the image-forming layer side could exposed to the outside to form a sample in the form of a roll. This sample in the form of a roll was set on FT-286R produced by NEC Corp. provided with a semiconductor laser of 785 nm. This plotter was connected to such a heat development apparatus as shown in FIG. 1 to perform light exposure and heat development.

6) Heat Development

The photothermographic material was transported from the aforementioned light exposure apparatus by an auto carrier and heat-developed in the heat development apparatus shown in FIG. 1 in an on-line manner. The roller surface material of the heat development section was composed of silicone rubber, and the flat surface consisted of Teflon non-woven fabric. The transportation line speed in the heat development section was 25 mm/second. The heat development was performed for 12.2 seconds in the preheating section (driving units of the preheating section and the heat development section were independent from each other, speed difference as to the heat development section was adjusted to −0.5% to −1%, speed difference as to the auto carrier was adjusted to 0% to −1.0%, and temperatures of each of the metallic rollers and processing times in the preheating section were as follows: first roller, 67° C. for 2.0 seconds; second roller, 82° C. for 2.0 seconds; third roller, 98° C. for 2.0 seconds; fourth roller, 107° C. for 2.0 seconds; fifth roller, 115° C. for2.0 seconds; and sixth roller, 120° C. for 2.0 seconds), for 17.2 seconds at 120° C. (surface temperature of photothermographic material) in the heat development section, and for 13.6 seconds in the gradual cooling section. The temperature precision as for the transverse direction was ±0.5° C. As for temperature setting of each roller, the temperature precision was secured by using a length of rollers longer than the width of the photothermographic material (for example, width of 61 cm) by 5 cm for the both sides and also heating the protruding portions. Since the rollers showed marked temperature decrease at the both end portions, the temperature of the portions protruding by 5 cm from the ends of the photothermographic material was controlled to be higher than that of the roller center by 1-3° C., so that uniform image density of finished developed image could be obtained for the whole photothermographic material (for example, within a width of 61 cm).

7) Evaluation of Photographic Performance

<<Evaluation of Density Unevenness>>

Photothermographic materials left in an environment of 25° C. and relative humidity of 80% for 16 hours were exposed for 50% half tone dot image of 175 lines/inch with a different quantity of light for every photothermographic material by using the aforementioned light exposure apparatus and heat-developed as described above in an environment of 25° C. and relative humidity of 80%. Then, density unevenness of the half tone dot image was evaluated by visual inspection. A sample showing no unevenness was determined to be Level 5, and as the unevenness became more significant, the level was represented with a smaller number. A sample of a level lower than Level 3 is unacceptable for practical use.

<<Evaluation of Image Line Width Fluctuation>>

Image line width fluctuation with fluctuation of humidity in development environment was evaluated as a difference of line widths obtained for a photothermographic material that was left in an environment of 25° C. and relative humidity of 80% for 16 hours, exposed at a line width of 60 μm in the same manner as the aforementioned light exposure in the same environment and subjected to the heat development, and a photothermographic material that was left in an environment of 25° C. and relative humidity of 40% for 16 hours, similarly exposed in the same environment and subjected to the heat development.

<<Evaluation of Dmax (Maximum Density)>>

Dmax (maximum density) was also evaluated in an environment of 25° C. and relative humidity of 40%. The density measurement was performed by using a Macbeth TD904 densitometer (visible density).

<<Evaluation of Gradation γ>>

In the aforementioned light exposure and heat development, the laser intensity was controlled to form a characteristic curve for density D/exposure Log E. The points corresponding to densities of 0.3 and 3.0 on the characteristic curve were connected, and the incline of the formed line (Tan θ) was shown as gradation γ.

8) Results

The results of the aforementioned evaluations for the prepared photothermographic material samples are shown Table 1.

TABLE 1

| | | Silica matting agent in non- | | | | | | | | |
|---|---|---|---|---|---|---|---|---|---|---|
| | | photosensitive layer | | | | | | | | |
| | Type of | Mean | Mono- | | Thickness of | Amount of | | | Image line | |
| | high | particle | dispersion | Coating | non- | residual | | | width | Evaluation |
| Photothermographic | contrast | size | degree | amount | photosensitive | solvent | | Gradation | fluctuation | of density |
| material No. | agent | (μm) | (%) | (mg/m²) | layer (μm) | (mg/m²) | Dmax | Υ | (μm) | unevenness |
| 1 (Comparative) | — | 3 | 10 | 10 | 2 | 150 | 1.5 | *a | 0 | 5 |
| 2 (Comparative) | — | 3 | 10 | 10 | 4 | 150 | 1.5 | *a | 0 | 5 |
| 3 (Comparative) | C-62 | 3 | 10 | 10 | 2 | 150 | 4.0 | 16 | 10 | 1 |
| 4 (Invention) | C-62 | 3 | 10 | 10 | 3 | 150 | 4.1 | 17 | 5 | 3 |
| 5 (Invention) | C-62 | 3 | 10 | 10 | 4 | 150 | 4.1 | 17 | 4 | 4 |
| 6 (Invention) | C-62 | 3 | 10 | 10 | 6 | 150 | 4.0 | 16.5 | 2 | 5 |
| 7 (Comparative) | C-62 | 3 | 10 | 10 | 10 | 150 | 3.0 | 10 | 2 | 5 |
| 8 (Invention) | C-62 | 3 | 10 | 10 | 4 | 70 | 3.8 | 17 | 3 | 4 |
| 9 (Invention) | C-62 | 3 | 10 | 10 | 4 | 30 | 4.0 | 16.5 | 3 | 5 |
| 10 (Invention) | C-62 | 3 | 10 | 10 | 4 | 10 | 3.9 | 16 | 2 | 5 |
| 11 (Invention) | C-62 | 3 | 10 | 10 | 4 | 2 | 3.6 | 15 | 1.5 | 5 |
| 12 (Invention) | C-62 | 3 | 10 | 10 | 4 | 400 | 4.3 | 18 | 5 | 3 |
| 13 (Invention) | C-62 | 3 | 40 | 10 | 4 | 70 | 3.8 | 17 | 3 | 4 |
| 14 (Invention) | C-62 | 4 | 10 | 10 | 4 | 70 | 3.8 | 17 | 3 | 4 |
| 15 (Invention) | C-62 | 5 | 10 | 10 | 4 | 70 | 3.7 | 16 | 3 | 4 |
| 16 (Comparative) | C-1 | 3 | 10 | 10 | 2 | 150 | 3.9 | 16.5 | 11 | 1 |
| 17 (Invention) | C-1 | 3 | 10 | 10 | 4 | 150 | 3.9 | 17 | 5 | 4 |
| 18 (Comparative) | C-8 | 3 | 10 | 10 | 2 | 150 | 4.0 | 16 | 10 | 1 |
| 19 (Invention) | C-8 | 3 | 10 | 10 | 4 | 150 | 4.1 | 17 | 4 | 4 |
| 20 (Comparative) | C-65 | 3 | 10 | 10 | 2 | 150 | 3.8 | 16.5 | 11 | 1 |
| 21 (Invention) | C-65 | 3 | 10 | 10 | 4 | 150 | 3.9 | 17 | 4 | 4 |

*a: impossible to measure

As clearly seen from the results shown in Table 1, it was found that the photothermographic materials having the characteristics of the present invention could provide images of high Dmax (maximum density) and high contrast, and in addition, showed little image line width fluctuation and no generation of density unevenness in image areas even with heat development in a highly humid environment.

### Example 2

The samples used in Example 1 were exposed and heat-developed by using an A2 size plotter, FT-286R, produced by NEC Corp., a dry film processor, FDS-6100X, produced by Fuji Photo Film Co., Ltd., and a dry system auto carrier, FDS-C1000, produced by Fuji Photo Film Co., Ltd., and similarly evaluated. As a result, results similar to those of Example 1 were obtained. Thus, the advantages of the present invention were clearly demonstrated.

What is claimed is:

1. A photothermographic material containing a silver salt of an organic acid, a photosensitive silver halide, a reducing agent, a high contrast agent and a binder on a support and having one or more image-forming layer and one or more layers on the outermost image-forming layer, wherein at least one of the layers on the outermost image-forming layer is a non-photosensitive layer having a thickness of 2.8-8 μm and at least one layer prepared by applying a coating solution containing 30 weight % or more of an organic solvent is formed between the support and the non-photosensitive layer.

2. The photothermographic material according to claim 1, wherein the layer prepared by applying a coating solution containing 30 weight % or more of an organic solvent is an image-forming layer.

3. The photothermographic material according to claim 1, wherein at least one layer prepared by applying a coating solution containing 30-80 weight % or more of an organic solvent is formed between the support and the non-photosensitive layer.

4. The photothermographic material according to claim 1, wherein the non-photosensitive layer has a thickness of 3-8 μm.

5. The photothermographic material according to claim 1, wherein the non-photosensitive layer has a thickness of 3.5-7 μm.

6. The photothermographic material according to claim 1, wherein 50% by weight or more of binder in the non-photosensitive layer consists of a cellulose derivative.

7. The photothermographic material according to claim 1, wherein 50% by weight or more of binder in the non-photosensitive layer consists of cellulose acetate and/or cellulose acetate butyrate.

8. The photothermographic material according to claim 1, wherein 50% by weight or more of binder in the non-photosensitive layer consists of cellulose acetate butyrate.

9. The photothermographic material according to claim 1, wherein the non-photosensitive layer contains a binder in an amount of 2.6-10 g/m².

10. The photothermographic material according to claim 1, wherein the non-photosensitive layer contains a binder in an amount of 3-9 g/m².

11. The photothermographic material according to claim 1, which contains a matting agent in an amount of 0.5-30% by weight of the total amount of the binder on the image-forming layer side.

12. The photothermographic material according to claim 1, wherein the non-photosensitive layer contains a silica matting agent having a mean particle size of 3.5 μm or less and a monodispersion degree of 30% or less for particle size.

13. The photothermographic material according to claim 1, which contains 5-300 mg/m² of residual organic solvent upon heat development.

14. The photothermographic material according to claim 1, which contains 5-150 mg/m² of residual organic solvent upon heat development.

15. The photothermographic material according to claim 1, wherein the high contrast agent consists of at least one compound selected from compounds represented by the following formula (1), (2) or (3): 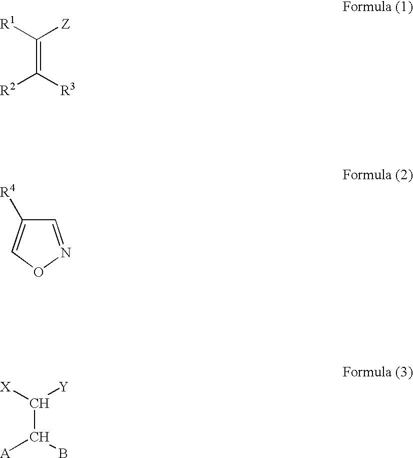
wherein, in the formula (1), R¹, R²and R³each independently represent a hydrogen atom or a substituent, and Z represents an electron-withdrawing group or a silyl group. In the formula (1), R¹ and Z, R² and R³, R¹ and R², or R³ and Z may bond to each other to form a ring structure. In the formula (2), R⁴ represents a substituent. In the formula (3), X and Y each independently represent a hydrogen atom or a substituent, and A and B each independently represent an alkoxyl group, an alkylthio group, an alkylamino group, an aryloxy group, an arylthio group, an anilino group, a heterocyclyloxy group, a heterocyclylthio group or a heterocyclylamino group. In the formula (3), X and Y, or A and B may bond to each other to form a ring structure.

16. The photothermographic material according to claim 15, wherein the compounds represented by the formula (1), (2) or (3) are contained in an amount of 2×10⁻⁵ to 2×10⁻¹ mol per mole of silver.

17. The photothermographic material according to claim 1, wherein the high contrast agent is a hydrazine compound.

18. The photothermographic material according to claim 17, wherein the hydrazine compound is contained in an amount of 2×10⁻⁵ to 5×10⁻³ mol per mole of silver.

19. The photothermographic material according to claim 1, wherein the high contrast agent is contained in the image-forming layer or a layer adjacent thereto.

20. The photothermographic material according to claim 1, which is in the form of a sheet having a width of 550-650 mm and a length of 1-65 m and a part or all of which is rolled around a core member of cylindrical shape so that the image-forming layer side can be exposed to the outside.
